(19) United States
(12) Patent Application Publication
(10) Pub. No.: US 2026/0246485 A1
(43) Pub. Date: Aug. 20, 2026

(54) TRIGGERING DIGITAL PREDISTORTION TRAINING USING A REVERSE SIGNAL

(71) Applicant: QUALCOMM Incorporated, San Diego, CA (US)

(72) Inventors: Yuval BEN HUR, Nesher (IL); Ariel Yaakov SAGI, Haifa (IL); Evgeny LEVITAN, Haifa (IL)

(21) Appl. No.: 19/054,589

(22) Filed: Feb. 14, 2025

(51) Int. Cl. H04B 1/04; H04B 7/0413

(52) U.S. Cl. CPC H04B 1/0475; H04B 7/0413; H04B 2001/0425

(57) ABSTRACT

Various aspects of the present disclosure generally relate to wireless communication. In some aspects, an apparatus may generate a set of digital samples using a reverse signal that is based at least in part on at least one of: crosstalk associated with an antenna panel, or a reflection that is based at least in part on a forward signal that is associated with a multiple-input-multiple-output (MIMO) communication via the antenna panel. The apparatus may compute a digital predistortion (DPD) training trigger decision based at least in part on the set of digital samples of the reverse signal. The apparatus may trigger, selectively and based at least in part on the DPD training trigger decision, a DPD training module to generate one or more DPD coefficients based at least in part on the set of digital samples of the reverse signal. Numerous other aspects are described.

### FIELD OF THE DISCLOSURE

Aspects of the present disclosure generally relate to wireless communication and specifically relate to techniques, apparatuses, and methods associated with triggering digital predistortion training using a reverse signal.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

A wireless transmitter may transmit signals with increasing nonlinearity based at least in part on power increases. For example, the transmitter may include a power amplifier (PA) with a limited dynamic range that may distort a transmitted signal as a result of a relatively high peak-to-average power ratio (PAPR). To avoid nonlinearity distortions and accompanying interference, the transmitter may apply a power back-off value to reduce transmit power, thereby reducing nonlinearity. In some cases, applying a power back-off value may result in reduced power efficiency (e.g., less available transmit power is used to transmit in a channel, thereby reducing range, signal-to-interference-plus-noise ratio, and/or the like). To illustrate, based at least in part on applying the power back-off value, the transmitter may transmit the signal with less power in the channel and may dissipate more power as heat, which may result in reduced power efficiency. Accordingly, the transmitter may use one or more pre-transmission signal processing techniques to reduce the power back-off value. For example, the transmitter may utilize digital predistortion (DPD) processing configured to reduce nonlinear distortion to less than a threshold level, enabling operation with a reduced level of power back-off.

A transmitter may alternatively or additionally include multiple-input-multiple-output (MIMO) capabilities that enable the transmitter to transmit multiple signals simultaneously as different layers of a MIMO transmission. As one example, the transmitter may include a first transmission chain that includes a first DPD component connected to a first PA and a second transmission chain that includes a second DPD component connected to a second PA. Each transmission chain may process a respective signal based at least in part on applying respective DPD and respective power amplification to the respective signal. The first transmission chain may generate a first forward signal that is fed into an antenna panel, and the second transmission chain may generate a second forward signal that is also fed into the antenna panel.

### SUMMARY

Some aspects described herein relate to an apparatus comprising a digital predistortion (DPD) training trigger module that includes: a first input to receive at least a reverse signal that is based at least in part on at least one of: crosstalk that is associated with an antenna panel, or a reflection that is based at least in part on the antenna panel and a forward signal that is associated with a multiple-input-multiple-output (MIMO) communication via the antenna panel; and a first output to communicate at least a DPD training trigger decision that is based at least in part on the reverse signal. The apparatus may also comprise a DPD training module that includes one or more second inputs to receive at least: the DPD training trigger decision, the forward signal, and the reverse signal. The DPD training module may include a training system configured to generate, based at least in part on the DPD training trigger decision, one or more DPD coefficients using at least the forward signal and the reverse signal. In some aspects, the DPD training module includes a second output to output the one or more DPD coefficients based at least in part on the DPD training trigger decision.

Some aspects described herein relate to an apparatus comprising an antenna panel, a DPD circuit that includes a first input and a power amplifier (PA) that is coupled to the antenna panel and the DPD circuit. The apparatus may also include a DPD training trigger module that comprises one or more second inputs to receive at least: a forward signal that is associated with a MIMO communication and is an input to the antenna panel; and a reverse signal that is based at least in part on at least one of: crosstalk that is associated with the antenna panel, or a reflection that is based at least in part on the antenna panel and the forward signal. The DPD training trigger module may include a first output to communicate at least: a DPD training trigger decision that is based at least in part on the reverse signal. In some aspects, the apparatus includes a DPD training module that comprises one or more third inputs to receive at least: the DPD training trigger decision, the forward signal, and the reverse signal. The DPD training module may include a training system that generates, based at least in part on the DPD training trigger decision, one or more DPD coefficients using at least the forward signal and the reverse signal. Alternatively, or additionally, the DPD training module includes a second output that is coupled to the first input of the DPD circuit, the second output configured to output the one or more DPD coefficients based at least in part on the DPD training trigger decision.

Some aspects described herein relate to an apparatus comprising: a plurality of transmit chains each comprising a power amplifier, the plurality of transmit chains coupled to an antenna array comprising a plurality of antennas. The apparatus may also include one or more feedback circuits, each of the one or more feedback circuits comprising an electrical isolation circuit that is configured to capture at least a portion of a signal between the power amplifier of at least one of the plurality of transmit chains and the antenna array. In some aspects, each feedback circuit of the one or more feedback circuits may output a reverse signal corresponding to a signal passing in a direction from the antenna array towards the power amplifier. In some aspects, each of the one or more feedback circuits is configured to output a feedback signal based on the reverse signal. The apparatus may also include a DPD circuit that is included as a part of one or more of the plurality of transmit chains or coupled to the one or more of the plurality of transmit chains, and the digital predistortion circuit may be configured to receive the feedback signal that is based on the reverse signal from the one or more feedback circuits. An example of a feedback signal is a DPD training trigger decision.

Some aspects described herein relate to a method performed by an apparatus. The method may include generating a set of digital samples of a reverse signal that is based at least in part on at least one of: crosstalk that is associated with an antenna panel, or a reflection that is based at least in part on the antenna panel and a forward signal that is associated with a MIMO communication via the antenna panel. The method may include computing, selectively, one or more DPD coefficients based at least in part on a DPD training trigger decision, the DPD training trigger decision being based at least in part on the set of digital samples of the reverse signal.

Some aspects described herein relate to an apparatus for wireless communication at an apparatus. The apparatus may include one or more memories and one or more processors coupled to the one or more memories. The one or more processors may be configured to generate a set of digital samples of a reverse signal that is based at least in part on at least one of: crosstalk that is associated with an antenna panel, or a reflection that is based at least in part on the antenna panel and a forward signal that is associated with a MIMO communication via the antenna panel. The one or more processors may be configured to compute, selectively, one or more DPD coefficients based at least in part on a DPD training trigger decision, the DPD training trigger decision being based at least in part on the set of digital samples of the reverse signal.

Some aspects described herein relate to a non-transitory computer-readable medium that stores a set of instructions for wireless communication by a one or more instructions. The set of instructions, when executed by one or more processors of an apparatus, may cause the apparatus to generate a set of digital samples using a reverse signal that is based at least in part on at least one of: crosstalk that is associated with an antenna panel, or a reflection that is based at least in part on the antenna panel and a forward signal that is associated with a MIMO communication via the antenna panel. The set of instructions, when executed by one or more processors of the apparatus, may cause the apparatus to compute, selectively, one or more DPD coefficients based at least in part on a DPD training trigger decision, the DPD training trigger decision being based at least in part on the set of digital samples of the reverse signal.

Some aspects described herein relate to an apparatus for wireless communication. The apparatus may include means for generating a set of digital samples using a reverse signal that is based at least in part on at least one of: crosstalk that is associated with an antenna panel, or a reflection that is based at least in part on the antenna panel and a forward signal that is associated with a MIMO communication via the antenna panel. The apparatus may include means for computing, selectively, one or more DPD coefficients based at least in part on a DPD training trigger decision, the DPD training trigger decision being based at least in part on the set of digital samples of the reverse signal.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a wireless transceiver that may be used by a device to communicate in a wireless network, in accordance with the present disclosure.

FIGS. 4A and 4B are diagrams illustrating a first example that includes a transmitter that may include digital predistortion (DPD) capabilities, and a receiver that may include digital post-distortion capabilities, and a second example of multiple-input, multiple-output (MIMO) DPD in accordance with the present disclosure.

FIG. 5 is a diagram illustrating an example of MIMO DPD training that may be triggered based at least in part on a reverse signal, in accordance with the present disclosure.

FIG. 6 is a diagram illustrating an example process performed, for example, at a transmitter and/or transceiver apparatus, or an apparatus of a transmitter and/or transceiver, in accordance with the present disclosure.

FIG. 7 is a diagram illustrating an example artificial intelligence and/or machine learning model, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A wireless transmitter may transmit signals with increasing nonlinearity based at least in part on power increases. For example, the transmitter may include a power amplifier (PA) with a limited dynamic range that may distort a transmitted signal as a result of a relatively high peak-to-average power ratio (PAPR). To avoid nonlinearity distortions and accompanying interference, the transmitter may apply a power back-off value to reduce transmit power, thereby reducing nonlinearity. In some cases, applying a power back-off value may result in reduced power efficiency (e.g., less available transmit power is used to transmit in a channel, thereby reducing range, signal-to-interference-plus-noise ratio, and/or the like). To illustrate, based at least in part on applying the power back-off value, the transmitter may transmit the signal with less power in the channel and may dissipate more power as heat, which may result in reduced power efficiency. Accordingly, the transmitter may use one or more pre-transmission signal processing techniques to reduce the power back-off value. For example, the transmitter may utilize digital predistortion (DPD) processing configured to reduce nonlinear distortion to less than a threshold level, enabling operation with a reduced level of power back-off.

A transmitter may alternatively or additionally include multiple-input-multiple-output (MIMO) capabilities that enable the transmitter to transmit multiple signals simultaneously as different layers of a MIMO transmission. As one example, the transmitter may include a first transmission chain that includes a first DPD component connected to a first PA and a second transmission chain that includes a second DPD component connected to a second PA. Each transmission chain may process a respective signal based at least in part on applying respective DPD and respective power amplification to the respective signal. The first transmission chain may generate a first forward signal that is fed into an antenna panel, and the second transmission chain may generate a second forward signal that is also fed into the antenna panel.

In some scenarios, as the first forward signal propagates and encounters the antenna panel, a portion of the first forward signal may reflect, resulting in a return signal and/or a reverse signal that may interfere with and/or distort the first forward signal. Alternatively, or additionally, as the second forward signal propagates and encounters the antenna panel, unintentional coupling between antenna elements in the antenna panel may result in crosstalk that generates an interfering signal and/or a reverse signal that may also interfere with and/or distort the first forward signal. The interference introduced via the return signal associated with the first forward signal and/or the crosstalk interfering signal associated with the second forward signal may, in some cases, be non-linear. A transmitter may include one or more circulators (or other isolators, physical isolation elements, or layout techniques that provide electrical isolation) to control signal flow and/or to mitigate reflections and/or crosstalk. To illustrate, the transmitter may position a circulator between a forward signal path to an antenna element and a reverse signal path from the antenna element to provide isolation and mitigate distortion. However, as a quantity of antenna elements used by a transmitter increases, a quantity of circulators used by the transmitter may also increase. Based at least in part on a variety of factors (e.g., size, cost, frequency band dependency, and/or thermal management), increasing a quantity of circulators in a transmitter may be infeasible and/or impractical.

As an alternative to a circulator, a transmitter may include one or more DPD components that are configured to apply DPD to a signal that pre-corrects for the effects of a reverse signal (e.g., a return signal and/or a crosstalk interfering signal) and may mitigate the effects of the reverse signal (e.g., interference with and/or distortion to a forward signal based at least in part on a reflection and/or crosstalk). A DPD configuration that applies pre-correction to mitigate the effects of a reverse signal may also be referred to as MIMO DPD. “MIMO DPD” denotes a PA linearization technique that applies digital predistortion that is based at least in part on transmissions and interference from all active chains in a MIMO system to minimize PA distortion and/or mitigate interference. As one example, a DPD component may be configured to process an input stream using one or more DPD kernels, and the DPD kernel(s) may apply the DPD to the input stream by performing computations that are based at least in part on a predistortion network model. In some cases, the computations associated with the predistortion network model may be implemented based at least in part on one or more coefficients (e.g., DPD coefficients) that may be used to apply the DPD to the input stream. Some scenarios generate the DPD coefficients using a training procedure in which a software model (e.g., a machine learning (ML) model) uses input data in combination with known (correct) outputs to guide the training procedure. For instance, an ML training procedure may compute the DPD coefficients based at least in part on using input that includes any combination of a signal without distortion, the signal with interference and/or distortion, crosstalk knowledge, and/or return signal knowledge to iteratively compute DPD coefficients that mitigate the effects of a reverse signal (e.g., distortion and/or interference) to a forward signal.

One operating condition for using MIMO DPD to mitigate the effects of a reverse signal on a forward signal is that a current operating environment and/or a current operating setting of a DPD component is commensurate with a training setting that was used to generate the DPD coefficients used by the DPD component. To illustrate, an operating environment may be based at least in part on one or more characteristics of distortion and/or interference that are observed at a transmitter and, consequently, the DPD component uses the DPD coefficients. The operating condition may specify that, to ensure that the applied DPD results in a forward signal that satisfies a quality threshold, the characteristics of a current operating environment be commensurate (e.g., within a threshold and/or a range) with the distortion and/or the interference used to train and/or generate the DPD coefficients. An example of a quality threshold is a quality threshold that is based at least in part on any combination of an amount of phase distortion and/or power distortion, clipping, and/or a modulation quality. Accordingly, ensuring that the DPD applied by a DPD component results in a forward signal that satisfies a quality threshold may rely upon a current operating environment observed at a transmitter being commensurate and/or synchronized with a training environment (e.g., to within a threshold or range of accuracy).

Maintaining synchronization between a training environment used to generate DPD coefficients and a current operating environment may be challenging based on a variety of factors. To illustrate, the operating environment at a transmitter may change frequently, and the changes may result in a mismatch between the DPD coefficients used by a DPD component and the current operating environment. That is, the changes may result in a mismatch between a current operating environment at the transmitter and a training environment used to generate the DPD coefficients. For instance, the transmitter may use beamforming to transmit a signal in a specific direction, and the transmitter may change the beamforming frequently based at least in part on user equipment (UE) mobility. The transmitter changing a beamforming configuration may result in alterations to a per-transmission chain power and, consequently, may lead to a mismatch between the DPD coefficients used by a DPD component (e.g., and the corresponding training environment) and the current operating environment. A mismatch between the DPD coefficients and the current operating environment may result in the transmitter applying DPD to a signal that does not mitigate the reverse signal effects to within a quality threshold, reduced signal quality (e.g., increased phase distortion and/or power distortion, clipping, and/or reduced modulation quality), increased recovery errors at a receiver, increased data transfer latencies, and/or reduced data throughput.

Various aspects relate generally to triggering digital predistortion training using a reverse signal. Some aspects more specifically relate to routing a reverse signal to a DPD training trigger module that uses at least the reverse signal to selectively trigger DPD training that generates DPD coefficients. In some aspects, an apparatus may generate a set of digital samples of a reverse signal, such as crosstalk that is associated with an antenna panel and/or a reflection of a forward signal that is fed to the antenna panel. The reverse signal (e.g., the crosstalk and/or the reflection) may be associated with a MIMO communication via the antenna panel. The apparatus may compute, selectively, one or more DPD coefficients based at least in part on a DPD training trigger decision, the DPD training trigger decision being based at least in part on the set of digital samples of the reverse signal. As one example, the apparatus may compute the DPD training decision using the set of digital samples, and may selectively trigger a DPD training module to generate the DPD coefficients. For instance, the apparatus may compute a measurement metric using the set of digital samples, and may trigger the DPD training module based at least in part on the measurement metric satisfying the threshold. Alternatively, the apparatus may not trigger the DPD training module based at least in part on the measurement metric failing to satisfy the threshold.

In some aspects, an apparatus may include a DPD training trigger module. The DPD training trigger module may include at least a first input to receive a reverse signal and a first output to communicate at least a DPD training trigger decision that is based at least in part on the reverse signal. In some aspects, the first input of the DPD training trigger module may be configured to receive a reverse signal that is based at least in part on crosstalk that is associated with an antenna panel and/or a reflection of a forward signal that is associated with a MIMO communication via the antenna panel. The apparatus may include and/or connect to a DPD training module, and the DPD training module may include one or more second inputs to receive any combination of the DPD training trigger decision, the forward signal, and/or the reverse signal. The DPD training module may also include a training system that generates, based at least in part on the DPD training trigger decision, one or more DPD coefficients using at least the forward signal and the reverse signal. As one example, the DPD training module may compute the DPD coefficients based at least in part on minimizing a difference between one or more observed values (e.g., of a reverse signal) and a predicted value (e.g., via a crosstalk matrix as described below) such as through the use of a least-squares-based algorithm, a mean absolute error (MAE)-based algorithm, and/or a maximum likelihood estimation (MLE)-based algorithm. As another example, the DPD training module may be based at least in part on machine learning (ML) and/or artificial intelligence (AI). The DPD training module may include a second output to output the one or more DPD coefficients, where the DPD training module may selectively output the DPD coefficients based at least in part on the DPD training trigger decision.

In some aspects, an apparatus may include a plurality of transmit chains, each transmit chain including a power amplifier, where the plurality of transmit chains are coupled to an antenna array comprising a plurality of antennas. The apparatus may also include one or more feedback circuits, and each of the one or more feedback circuits may include an electrical isolation circuit that is configured to capture at least a portion of a signal between the power amplifier of at least one of the plurality of transmit chains and the antenna array. Each feedback circuit may be configured to output a reverse signal corresponding to a signal passing in a direction from the antenna array towards the power amplifier, each feedback circuit of the one or more feedback circuits being configured to output a feedback signal based on the reverse signal. The apparatus may include a DPD circuit that is included as a part of one or more of the plurality of transmit chains or is coupled to the one or more of the plurality of transmit chains. The DPD circuit may be configured to receive the feedback signal that is based on the reverse signal from the one or more feedback circuits. An example of a feedback signal is a DPD training trigger decision.

In some aspects, an apparatus may include an antenna panel, a DPD circuit that includes a first input, and a PA that is coupled to the antenna panel and the DPD circuit. The apparatus may include and/or be connected to a DPD training trigger module, and the DPD training trigger module may include one or more second inputs to receive a forward signal and a reverse signal. In some aspects, the DPD training trigger module may be configured to receive a forward signal that is associated with a MIMO communication and is an input signal to the antenna panel. Alternatively, or additionally, the DPD training trigger module may be configured to receive a reverse signal that is based at least in part on crosstalk that is associated with the antenna panel and/or a reflection that is based at least in part on the antenna panel and the forward signal. The DPD training trigger module may include a first output to communicate at least a DPD training trigger decision that is based at least in part on the reverse signal. In some aspects, the apparatus may include and/or be connected to a DPD training module, and the DPD training module may include one or more third inputs to receive at least the DPD training trigger decision, the forward signal, and/or the reverse signal. Alternatively, or additionally, the DPD training module may include a training system that generates, based at least in part on the DPD training trigger decision, one or more DPD coefficients using at least the forward signal and the reverse signal. In some aspects, the DPD training module may include a second output that is coupled to the first input of the DPD circuit. The second output may be configured to output the one or more DPD coefficients based at least in part on the DPD training trigger decision.

Particular aspects of the subject matter described in this disclosure can be implemented to realize one or more of the following potential advantages. In some examples, by capturing and analyzing a reverse signal, the described techniques can be used to enable an apparatus (e.g., a computing device, a transmitter, an integrated circuit (IC), a system-on-chip (SoC), a digital signal processor (DSP), a field programmable gate array (FPGA), an application-specific integrated circuit (ASIC), a programmable logic device (PLD), or other discrete gate or transistor logic or circuitry) to identify a mismatch between current DPD coefficients being used by a DPD component and a current operating environment, and the apparatus may compute and/or derive a system-level DPD training trigger decision on generating DPD coefficients. For example, the apparatus may include and/or be connected to a DPD training trigger module that receives at least the reverse signal as input and analyzes at least the reverse signal to make a determination on whether or not to trigger DPD training that generates DPD coefficients. In analyzing the reverse signal, the DPD training trigger module may identify that a current operating condition and/or a current signal characteristic (e.g., a reverse signal power level, a reverse signal frequency offset, and/or a reverse signal phase relationship) differs from a training operating condition and/or a training signal characteristic that was used to generate the current DPD coefficients being used by a DPD component. The apparatus may trigger, by way of the DPD training trigger module, a DPD training module to generate DPD coefficients that are based at least in part on the current operating environment and/or the current signal characteristic of the reverse signal (e.g., current interference level, current distortion level, and/or current crosstalk level). DPD coefficients that match a current operating environment (e.g., to within a threshold) may result in increased accuracy of the DPD applied by a DPD component, an increased a signal quality (e.g., decreased phase, decreased power distortion, no clipping, and/or increased modulation quality) at a transmitter, reduced recovery errors at a receiver, reduced data transfer latencies, and/or increased data throughput.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

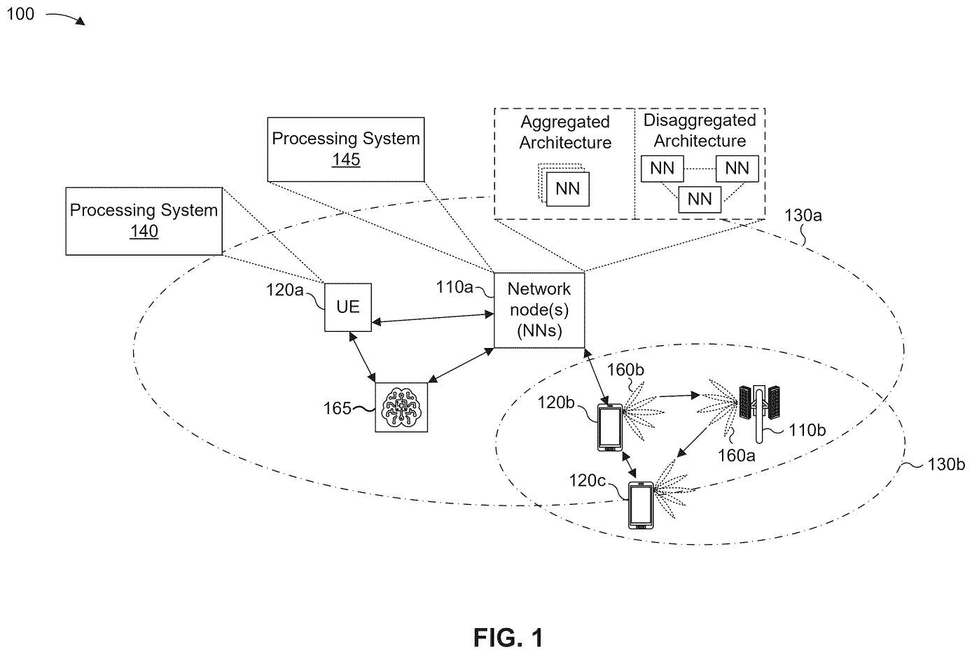

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, SoCs, chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or DSPs), processing blocks, ASICs, PLDs, or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

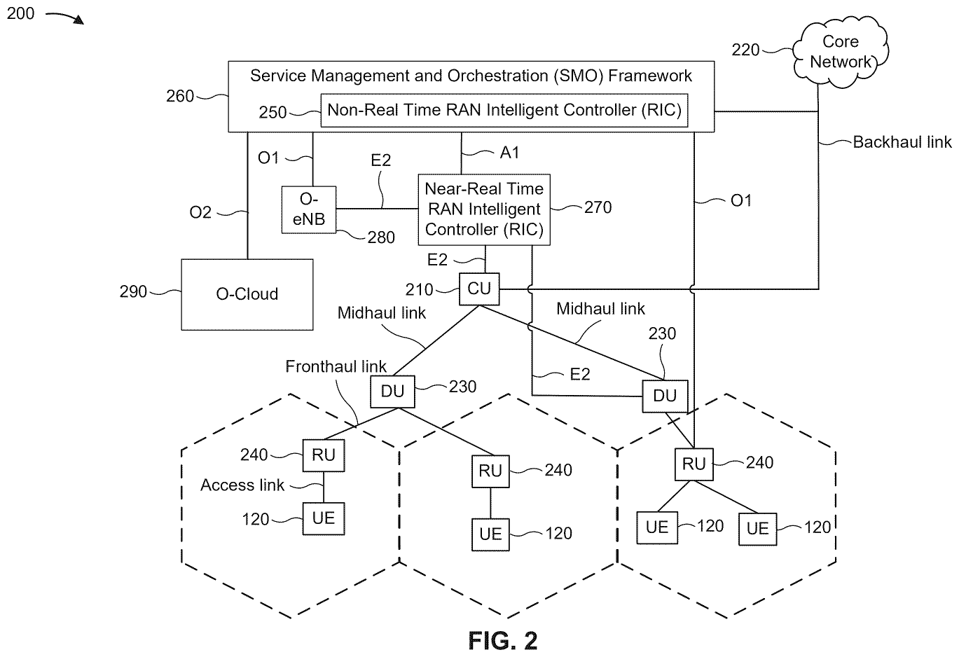

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, one or more network nodes 110, one or more UEs 120, and/or one or more servers, and/or one or more components of a cloud computing network, among other examples). For example, in an deployment where AI/ML functionality is performed independently at a device 165, sometimes referred to as “overlay AI/ML”, the AI/ML model (or an instance or portion of the AI/ML model) may be deployed at a UE 120 (for example, at the processing system 140), a network node 110 (for example, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, and/or efficient use of network bandwidth, and/or to reduce latency, among other examples). For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (for example, according to a geographical area where measurements are to be collected and/or UE capabilities to be used to collected measurements), and/or reporting configurations (for example, reporting parameters such as location, time, and/or sensor information, among other examples). Additionally or alternatively, the AI/ML model(s) may enable AI/ML procedures (for example, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, an apparatus (e.g., a network node 110, a processing system 145, a UE 120, and/or a processing system 140) may generate a set of digital samples using a reverse signal that is based at least in part on at least one of: crosstalk that is associated with an antenna panel, or a reflection that is based at least in part on the antenna panel and a forward signal that is associated with a MIMO communication via the antenna panel. The apparatus may compute, selectively, one or more DPD coefficients based at least in part on a DPD training trigger decision, the DPD training trigger decision being based at least in part on the set of digital samples of the reverse signal. Additionally, or alternatively, the apparatus may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

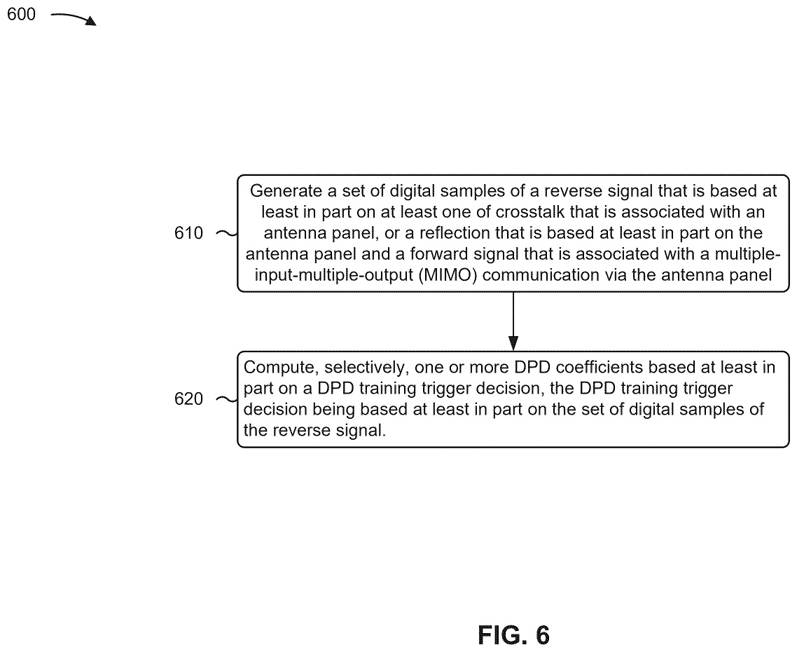

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with triggering DPD training using a reverse signal, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, or other processes as described herein. In some examples, executing instructions may include running the instructions, converting the instructions, compiling the instructions, and/or interpreting the instructions, among other examples.

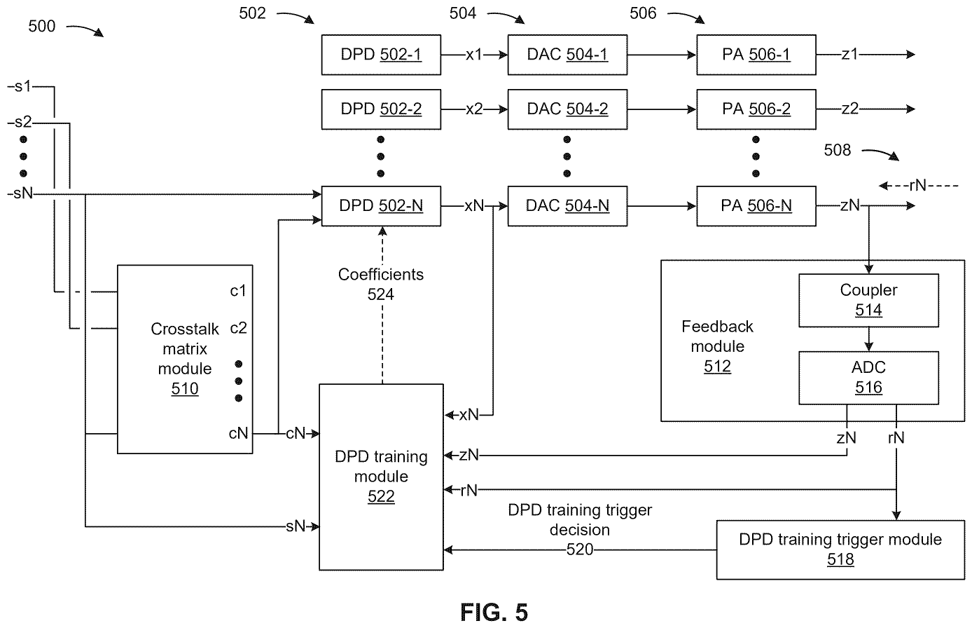

In some aspects, an apparatus (e.g., a network node 110, a processing system 145, a UE 120, and/or a processing system 140) includes means for generating a set of digital samples using a reverse signal that is based at least in part on at least one of: crosstalk that is associated with an antenna panel, or a reflection that is based at least in part on the antenna panel and a forward signal that is associated with a MIMO communication via the antenna panel; means for computing, selectively, one or more DPD coefficients based at least in part on a DPD training trigger decision, the DPD training trigger decision being based at least in part on the set of digital samples of the reverse signal. In some aspects, the means for the apparatus to perform operations described herein may include, for example, one or more of processing system 140, processing system 145, a radio, one or more RF chains, one or more transceivers, one or more antennas, one or more modems, a reception component, a transmission component, a feedback module 512 as described below with regard to FIG. 5, a DPD trigger training module 512 as described below with regard to FIG. 5, and/or a DPD training module 522 as described below with regard to FIG. 5, among other examples.

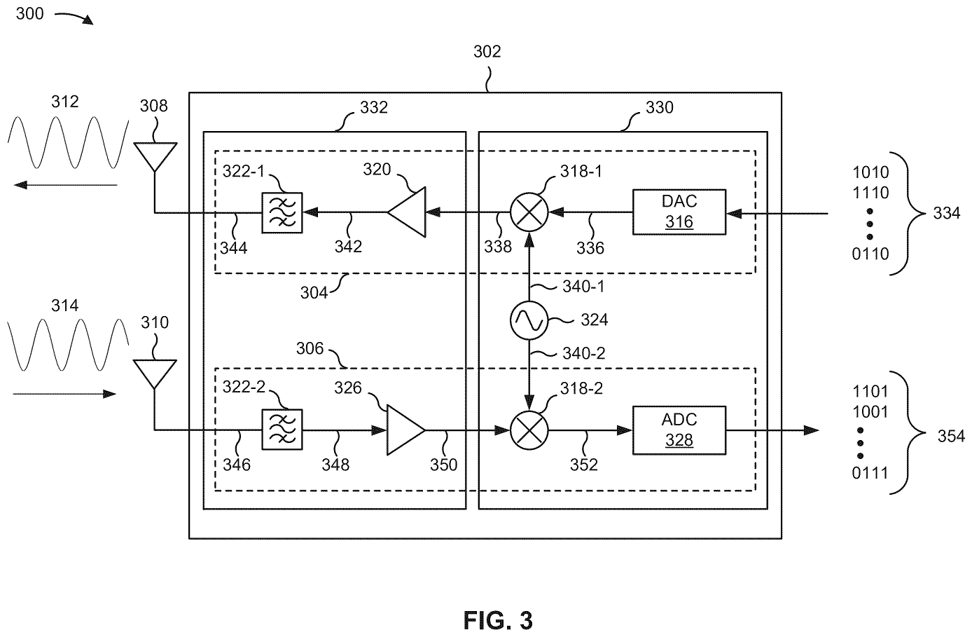

FIG. 3 is a diagram illustrating an example 300 of a wireless transceiver 302 that may be used by a device to communicate in a wireless network, in accordance with the present disclosure. A wireless transceiver 302 may include a transmitter 304 (shown with a dashed line) and/or a receiver 306 (shown with a dashed line). As shown by the example 300, the transmitter 304 may be coupled to at least a first antenna 308, and the receiver 306 may be coupled to at least a second antenna 310. However, in other examples, the transmitter 304 and the receiver 306 may be coupled to a same antenna through a switch and/or duplexer. In some aspects, the transmitter 304 may generate and transmit an outgoing RF signal 312, and the receiver 306 may receive and process an incoming RF signal 314.

As shown by the example 300, the transmitter 304 may include a digital-to-analog converter 316 (DAC 316), a first mixer 318-1, a first amplifier 320 (e.g., a power amplifier), and a first filter 322-1 (e.g., a surface-acoustic-wave (SAW) filter). The first mixer 318-1 may be coupled to a local oscillator (LO) 324. In some aspects, the DAC 316 may be coupled to an application processor or another processor associated with the wireless transceiver 302 (e.g., the modem 232 or the modem 254). Other examples of a transmitter may include multiple DACs, multiple mixers, multiple amplifiers, and/or multiple filters that are not shown by the example 300.

The receiver 306 may include a second filter 322-2 (e.g., a SAW filter), a second amplifier 326 (e.g., a low-noise amplifier), a second mixer 318-2, and an analog-to-digital converter 328 (ADC 328). The second mixer 318-2 may be coupled to the LO 324. Alternatively or additionally, the ADC 328 may be coupled to an application processor or another processor associated with the wireless transceiver 302 (e.g., the modem 232 or the modem 254). Other examples of a receiver may include multiple filters, multiple amplifiers, multiple mixers, and/or multiple ADCs that are not shown by the example 300.

In some aspects, the wireless transceiver 302 may be implemented using multiple circuits, such as multiple integrated circuits (ICs). To illustrate, the wireless transceiver 302 may include a transceiver circuit 330 and a radio-frequency front-end (RFFE) circuit 332. Accordingly, components used to form the transmitter 304 and the receiver 306 may be distributed across the multiple circuits. As one example, the transceiver circuit 330 and the RFFE circuit 332 may each include at least some components that form the transmitter 304 and/or at least some components that form the receiver 306. To illustrate, and with regard to the transmitter 304, the transceiver circuit 330 may include the DAC 316 and the first mixer 318-1 of the transmitter 304, and the RFFE circuit 332 may include the first amplifier 320 and the first filter 322-2 of the transmitter 304. Alternatively or additionally, and with regard to the receiver 306, the transceiver circuit 330 may include the second mixer 318-2 and the ADC 328 of the receiver 306, and the RFFE circuit 332 may include the second filter 322-2 and the second amplifier 326 of the receiver 306. In some aspects, the DAC 316 and/or the ADC 328 may be implemented on a circuit separate from the transceiver circuit 330, such as the modem 232 or the modem 254.

In some aspects, the transmitter 304 may generate the outgoing RF signal 312 based at least in part on one or more digital samples 334. A “digital sample”, which may alternatively be referred to as a sample, may denote a representation of an analog signal, such as an amplitude representation of the analog signal at a point in time. Each sample of a set of samples that span a time duration may represent the analog signal at a different point in time within the time duration. To illustrate, a first sample may represent the signal at a first point in time, a second sample may represent the signal at a second, different point in time, up to an n^{th} sample that may represent the signal at an n^{th} point in time, where n is an integer and the points in time that span the time duration may be uniformly separated in time. In some aspects, a sample may capture an in-phase/quadrature (I/Q) signal. For example, a sample may include an in-phase component (I-component) value associated with the I/Q signal at the point in time and a quadrature component (Q-component) value at the point in time. A sample associated with an I/Q signal (e.g., that includes an I-component and a Q-component) may alternatively or additionally be referred to as a complex sample.

In some aspects, the DAC 316 may receive, as the digital sample(s) 334, one or more samples associated with a pre-upconversion signal (e.g., a baseband signal or an intermediate frequency (IF) signal). In some aspects, the DAC 316 may receive one or more samples that include DPD. Using the digital sample(s) 334, the DAC 316 may generate, as an output, an analog pre-upconversion signal 336.

The first mixer 318-1 may receive the analog pre-upconversion signal 336 as input, and generate, as an output, a prefiltered upconverted signal 338 using an LO signal 340-1 provided by the LO 324. The prefiltered upconverted signal 338 may be an RF signal and/or may include some noise and/or unwanted frequencies, such as a harmonic frequency. The first amplifier 320 may receive the prefiltered upconverted signal 338 and generate an amplified prefiltered signal 342.

The first filter 322-2 may receive the amplified prefiltered signal 342 as input and filter the amplified pre-filter transmit signal 342 to generate a filtered transmit signal 344. As part of the filtering process, the first filter 322-2 may attenuate the noise or unwanted frequencies included in the prefiltered upconverted signal 338 and/or the amplified prefiltered signal 342. The transmitter 304 may provide the filtered transmit signal 344 to the first antenna 308 for transmission as the outgoing RF signal 312.

In some aspects, the receiver 306 may receive the incoming RF signal 314 using the second antenna 310. As shown by the example 300, the second antenna 310 may generate a prefiltered receive signal 346. The second antenna 310 may be coupled to the second filter 322-2 such that the second filter 322-2 receives and filters the prefiltered receive signal 346 to remove noise and/or unwanted frequencies. Accordingly, the second filter 322-2 may generate a filtered receive signal 348.

The second amplifier 326 may receive and amplify the filtered receive signal 348 to generate an amplified filtered receive signal 350. Based at least in part on being coupled to the second amplifier 326, the second mixer 318-2 may receive the amplified filtered receive signal 350 and downconvert the amplified filtered receive signal 350 using a LO signal 340-2 (e.g., from the LO 324) to generate a downconverted receive signal 352, which may be a baseband signal or an IF signal. The ADC 328 may receive the downconverted receive signal 352 and generate a digital signal by generating one or more digital samples 354 as output. The one or more digital samples 354 may be processed by a processor associated with the wireless transceiver 302 and/or another processor, such as a processor associated with the modem 232 or the modem 254.

As indicated above, FIG. 3 is provided as an example. Other examples may differ from what is described with regard to FIG. 3. As one example, the wireless transceiver 302 may include one or more feedback mechanisms, such as a feedback path (e.g., a feedback receiver) that provides feedback associated with an output from the first amplifier 320 to a DPD apparatus.

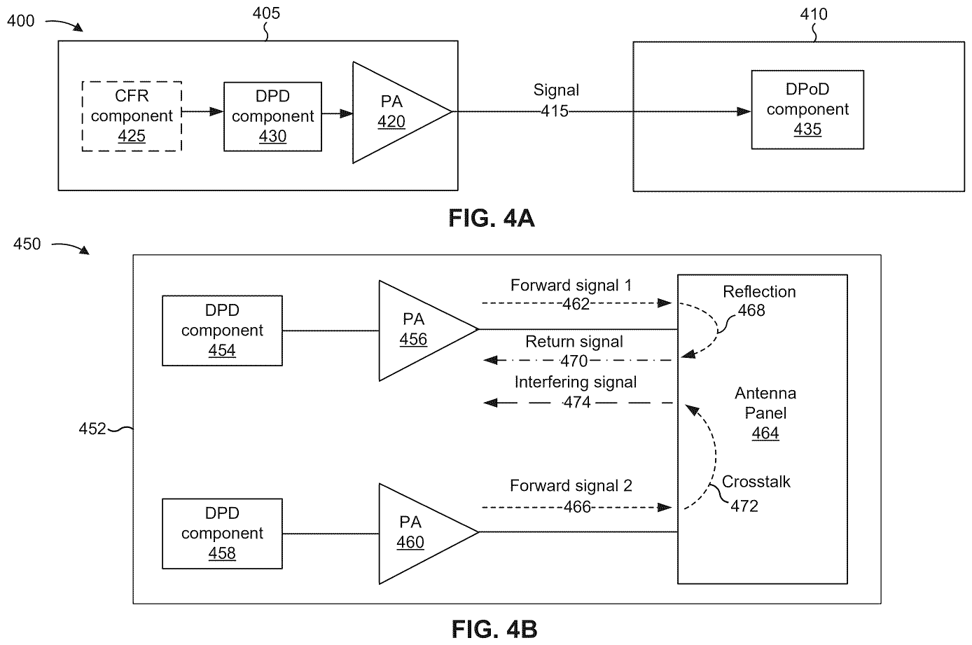

FIGS. 4A and 4B are diagrams illustrating a first example 400 that includes a transmitter 405 that may include DPD capabilities, and a receiver 410 that may include digital post-distortion (DPoD) capabilities, and a second example 450 of MIMO DPD) in accordance with the present disclosure. As shown in FIG. 4A, the transmitter 405 may communicate with the receiver 410 using a wireless signal 415. In some aspects, a network node 110 may include the transmitter 405 and UE 120 may include the receiver 410. Alternatively, or additionally, the UE 120 may include the transmitter 405 and the network node 110 may include the receiver 410. The block diagrams associated with the transmitter 405 and with the receiver 410 shown by the example 400 have been simplified for discussion purposes. Other examples may include alternative or additional features that have been omitted for clarity. For example, the transmitter 405 may include one or more components of the transmitter 304 described with regard to FIG. 3. Alternatively, or additionally, the transmitter 304 may include one or more components of the transmitter 405. As another example, the receiver 410 may include one or more components of the receiver 306 described with regard to FIG. 3 (or vice versa).

As shown by the first example 400, the transmitter 405 may communicate with the receiver 410 based at least in part on transmitting the signal 415 to the receiver 410. The signal 415 may be pre-processed by the transmitter 405 to, among other benefits, reduce a power-back off value associated with transmission of the signal 415 to the receiver 410.

To illustrate, in some communications systems, the transmitter 405 may transmit signals with increasing nonlinearity based at least in part on power increases. For example, the transmitter 405 may include a PA 420 (which, in some aspects, may be a high-power amplifier) with a limited dynamic range that may distort a transmitted signal as a result of a relatively high peak to average power ratio (PAPR). In some aspects, the PA 420 may be considered the first amplifier 320 as described with regard to FIG. 3. The nonlinear distortion may be an in-band distortion, which affects link performance in connection with mutual information and/or an error vector magnitude (EVM) amount, or an out-band distortion, which causes adjacent channel interference (ACI) and/or results in a high adjacent channel leakage ratio (ACLR) (e.g., the transmitted signal interferes with other signals on neighboring frequency bands, with the ACI and/or ACLR indicating how much the adjacent channel is polluted by a main transmission). To avoid nonlinearity distortions and accompanying interference, the transmitter 405 may apply a power back-off value to reduce transmit power, thereby reducing nonlinearity.

In some aspects, applying a power back-off value may result in reduced power efficiency (e.g., less available transmit power is used to transmit in a channel, thereby reducing range, signal to interference noise ratio, and/or the like). To illustrate, based at least in part on applying the power back-off value, the transmitter 405 may transmit the signal 415 with less power in channel and may dissipate more power as heat, which may result in reduced power efficiency. Accordingly, the transmitter 405 may use one or more pre-transmission signal processing techniques to reduce the power back-off value. For example, the transmitter may utilize crest factor reduction (CFR) processing and/or DPD processing. CFR processing may reduce the dynamic range of the signal, while DPD processing may reduce nonlinear distortion to less than a threshold level with a reduced level of power back-off, thereby increasing power efficiency relative to avoiding nonlinear distortion using only a power back-off. As shown in FIG. 4A, the transmitter 405 may thus include a CFR component 425 for performing CFR processing to the signal 415 (e.g., pre-DPD signal conditioning to reduce PAPR in the signal 415 as much as possible and thus reduce the power back-off value). While the transmitter 405 shown by FIG. 4 includes the CFR component 425, other transmitter implementations may exclude the CFR component 425, further indicated through the use of a dashed line. Alternatively or additionally, the transmitter 405 may include a DPD component 430 for performing DPD processing to the signal 415 (e.g., to linearize the power amplifier's response). As one example, the DPD component 430 may perform DPD processing on a digital signal such that the digital sample(s) 334 of FIG. 3 have been modified to include DPD. To illustrate, the transmitter 304 as described with regard to FIG. 3 may include the DPD component 430 prior to the DAC 316.

However, CFR processing consumes additional resources (e.g., bandwidth resources, power resources, computational resources, or the like), and, in some cases, CFR processing may introduce in-band distortion (e.g., EVM distortion) and/or out-band distortion (e.g., ACI distortion). Moreover, although DPD processing may correct an in-dynamic-range nonlinearity effect, nonlinearity may still cause a clipping effect (e.g., resulting from the limited dynamic range). Thus, the effectiveness and/or power efficiency benefit of CFR processing and DPD processing are limited.

To account for limitations of CFR and/or DPD processing, the receiver 410 may apply DPoD processing to the signal 415. DPoD processing may be similar to DPD processing but is performed in the receiver 410 rather than in the transmitter 405, and may be directed to processing for only EVM instead of processing for both EVM and ACI. More particularly, DPoD processing may be performed by a DPoD component 435 at the receiver 410, which may include hardware and/or software configured to implement an algorithm configured to remove nonlinear noise that is generated by a known model (e.g., PA clipping). DPoD processing thus may allow for reduced power back-out values and greater power efficiency.

The second example 450 shown by FIG. 4B includes a transmitter 452 with MIMO capabilities. To illustrate, the transmitter 452 includes a first transmission chain that includes a first DPD component 454 (e.g., a first DPD component 430) connected to a first PA 456 (e.g., a first PA 420) and a second transmission chain that includes a second DPD component 458 (e.g., a second DPD component 430) connected to a second PA 460 (e.g., a second PA 420). Each transmission chain may process a respective signal based at least in part on applying respective DPD and respective power amplification to the respective signal. The first transmission chain may generate a first forward signal 462 (shown by FIG. 4B as “forward signal 1” and through the use of a short-dash line) that is fed into an antenna panel 464. Similarly, the second transmission chain may generate a second forward signal 466 (shown by FIG. 4B as “forward signal 2” and through the use of a short-dash line) that is also fed into the antenna panel 464. The antenna panel 464 may transmit the first forward signal 462 and the second forward signal 466 simultaneously as different layers of a MIMO transmission, such as through the use of spatial multiplexing and/or polarization multiplexing.

In some examples, a transmitter may include one or more circulators (or other isolators, physical isolation elements, or layout techniques that provide electrical isolation) to control signal flow and/or to mitigate reflections and/or crosstalk. To illustrate, as the first forward signal 462 propagates and encounters the antenna panel 464, a portion of the first forward signal 462 may reflect as shown by reference number 468, resulting in a return signal 470 (shown with a dash-dot line) that may interfere with and/or distort the first forward signal 462. Alternatively, or additionally, as the second forward signal 466 propagates and encounters the antenna panel 464, unintentional coupling between antenna elements in the antenna panel 464 may result in crosstalk (as shown by reference number 472) that generates an interfering signal 474 (shown with a long-dash line). In a similar manner as the return signal 470, the interfering signal 474 may distort the first forward signal 462. By including a circulator in an RF chain, a transmitter may control signal flow to mitigate distortion and/or interference from a return signal (e.g., the return signal 470) and/or an interfering signal (e.g., the interfering signal 474). To illustrate, a circulator may provide isolation between a forward signal path and a reverse signal path, such as by routing a forward signal (e.g., the first forward signal 462) from a first port to a second port and by routing a reverse signal (e.g., the return signal 470 and/or the interfering signal 474) from the second port to a third port.

As a quantity of antenna elements used by a transmitter increases, a quantity of circulators used by the transmitter may also increase. For instance, in a MIMO system, a transmitter may include eight (8) antenna elements, and in a massive MIMO (mMIMO) system, the transmitter may include 64 or more antenna elements. In some use cases, a transmitter may include a same number of circulators as antenna elements, to increase isolation between each transmission path, and in other use cases, the transmitter may include fewer circulators than antenna elements. Based at least in part on a variety of factors (e.g., size, cost, frequency band dependency, and/or thermal management), increasing a quantity of circulators in a transmitter may be infeasible and/or impractical.

An alternative to a circulator is a DPD component that applies DPD (e.g., to an input signal) that is configured to pre-correct for the effects of a reverse signal (e.g., a return signal and/or an interfering signal). A DPD configuration that applies pre-correction to mitigate the effects of a reverse signal may also be referred to as MIMO DPD. “MIMO DPD” denotes a PA linearization technique that applies digital predistortion that is based at least in part on transmissions and interference from all active chains in a MIMO system to minimize PA distortion and/or mitigate interference. To illustrate, the DPD component may be configured to process an input stream using one or more DPD kernels, and the DPD kernel(s) may apply the DPD to the input stream by performing computations that are based at least in part on a predistortion network model. In some cases, the computations associated with the predistortion network model may be implemented based at least in part on one or more coefficients. For instance, the predistortion network model may partition a transmitter chain into sub-networks, and/or may characterize processing performed by each sub-network based at least in part on inputs to each sub-network and/or outputs from each sub-network. Inputs and outputs to/from the sub-networks may be modeled as complex baseband waveforms, and may include any combination of one or more forward signals, one or more reverse signals, one or more feed network signal inputs, one or more feed network signal outputs, and/or one or more antenna-network signal outputs.

Some scenarios generate the DPD coefficients using a training procedure in which a software model (e.g., a least-squares-based model, MAE-based model, an MLE-based model, an ML-based model, and/or an AI-based model) uses input data in combination with known (correct) outputs to guide the training procedure. For instance, with regard to DPD coefficients used by a DPD kernel, a training procedure may compute the DPD coefficients based at least in part on using input that includes any combination of a signal without distortion, the signal with interference and/or distortion, crosstalk knowledge, and/or a reverse signal (e.g., a return signal and/or an interfering signal) knowledge to iteratively compute DPD coefficients that mitigate distortion, interference, and/or crosstalk that is associated with the transmission chain.

One operating condition for using MIMO DPD to mitigate the effects of a reverse signal on a forward signal in a manner that generates a forward signal that satisfies a quality threshold is that a current operating environment and/or signal characteristics of a signal modified by a DPD component is commensurate with a training environment and/or a training signal that was used to generate the DPD coefficients applied by the DPD component. To illustrate, an operating environment and/or a signal characteristic may be based at least in part on a distortion level and/or interference level in a signal. The operating condition may specify that, to ensure that the applied DPD results in a forward signal that satisfies a quality threshold, the characteristics of a current operating environment be commensurate (e.g., within a threshold and/or a range) with the distortion and/or the interference used to train and/or generate the DPD coefficients. An example of a quality threshold includes a quality threshold that is based at least in part on any combination of an amount of phase distortion, power distortion, clipping, and/or a modulation quality in a signal. Accordingly, ensuring that the DPD applied by a DPD component results in a forward signal that satisfies a quality threshold may rely upon a current operating environment observed at a transmitter being commensurate and/or synchronized with a training environment (e.g., to within a threshold or range of accuracy).

Maintaining synchronization between a training environment used to generate DPD coefficients and a current operating environment may be challenging based on a variety of factors. To illustrate, the operating environment at a transmitter may change frequently, and the changes to the operating environment may result in a mismatch between the DPD coefficients used by a DPD component and the current operating environment. That is, the changes may result in a mismatch between a current operating environment at the transmitter and a training environment used to generate the DPD coefficients. For instance, the transmitter may use beamforming to transmit a signal in a specific direction based at least in part on applying a respective amplitude and/or respective phase (e.g., via beamforming coefficients) to each transmitting antenna element used to transmit the beamformed signal. In some cases, the transmitter may update beamforming coefficients frequently, such as on a per-slot basis and/or a per-symbol basis. Changes to the beamforming coefficients and, consequently, the transmitting antenna elements, may alter a per-transmission-chain power. Alternatively, or additionally, ACLR performance and/or EVM performance may significantly change for each beamforming coefficient update. Other example factors that may change an operating environment may include temperature variations and/or voltage standing wave ratio (VSWR) variations. These factors occurring at a transmitter that uses MIMO DPD to mitigate the effects of a reverse signal (e.g., distortion and/or interference) may result in a mismatch between a training environment associated with the DPD coefficients used by a DPD component and the current operating environment, resulting in DPD that does not mitigate the reverse signal effects to within a quality threshold. Failure to mitigate the reverse signal effects to within the quality threshold and/or the accuracy threshold may lead to reduced signal quality (e.g., increased phase distortion, increased power distortion, clipping, and/or reduced modulation quality), increased recovery errors at a receiver, increased data transfer latencies, and/or reduced data throughput.

Various aspects relate generally to triggering digital predistortion training using a reverse signal. Some aspects more specifically relate to routing a reverse signal to a DPD training trigger module that uses at least the reverse signal to selectively trigger DPD training that generates DPD coefficients. In some aspects, an apparatus may generate a set of digital samples using a reverse signal, such as crosstalk that is associated with an antenna panel and/or a reflection of a forward signal that is fed to the antenna panel. The reverse signal (e.g., the crosstalk and/or the reflection) may be associated with a MIMO communication via the antenna panel. The apparatus may compute, selectively, one or more DPD coefficients based at least in part on a DPD training trigger decision, the DPD training trigger decision being based at least in part on the set of digital samples of the reverse signal. As one example, the apparatus may compute the DPD training decision using the set of digital samples, and may selectively trigger a DPD training module to generate the DPD coefficients. For instance, the apparatus may compute a measurement metric using the set of digital samples, and may trigger the DPD training module based at least in part on the measurement metric satisfying the threshold. Alternatively, the apparatus may not trigger the DPD training module based at least in part on the measurement metric failing to satisfy the threshold.

In some aspects, an apparatus may include a DPD training trigger module. The DPD training trigger module may include at least a first input to receive a reverse signal and a first output to communicate at least a DPD training trigger decision that is based at least in part on the reverse signal. In some aspects, the first input of the DPD training trigger module may be configured to receive a reverse signal that is based at least in part on crosstalk that is associated with an antenna panel and/or a reflection of a forward signal that is associated with a MIMO communication via the antenna panel. The apparatus may include and/or connect to a DPD training module, and the DPD training module may include one or more second inputs to receive any combination of the DPD training trigger decision, the forward signal, and/or the reverse signal. The DPD training module may also include a training system that generates, based at least in part on the DPD training trigger decision, one or more DPD coefficients using at least the forward signal and the reverse signal. As one example, the DPD training module may compute the DPD coefficients based at least in part on minimizing a difference between one or more observed values (e.g., of a reverse signal) and a predicted value (e.g., via a crosstalk matrix as described below), such as through the use of a least-squares-based algorithm, an MAE-based algorithm, and/or an MLE-based algorithm. As another example, the DPD training module may be based at least in part on ML and/or AI. The DPD training module may include a second output to output the one or more DPD coefficients, where the DPD training module may selectively output the DPD coefficients based at least in part on the DPD training trigger decision.

In some aspects, an apparatus may include a plurality of transmit chains, each transmit chain including a power amplifier, where the plurality of transmit chains are coupled to an antenna array comprising a plurality of antennas. The apparatus may also include one or more feedback circuits, and each of the one or more feedback circuits may include an electrical isolation circuit that is configured to capture at least a portion of a signal between the power amplifier of at least one of the plurality of transmit chains and the antenna array. Each feedback circuit may be configured to output a reverse signal corresponding to a signal passing in a direction from the antenna array towards the power amplifier, each feedback circuit of the one or more feedback circuits being configured to output a feedback signal based on the reverse signal. The apparatus may include a DPD circuit that is included as a part of one or more of the plurality of transmit chains or is coupled to the one or more of the plurality of transmit chains. The DPD circuit may be configured to receive the feedback signal that is based on the reverse signal from the one or more feedback circuits. An example of a feedback signal is a DPD training trigger decision.

In some aspects, an apparatus may include an antenna panel, a DPD circuit that includes a first input, and a PA that is coupled to the antenna panel and the DPD circuit. The apparatus may include and/or be connected to a DPD training trigger module, and the DPD training trigger module may include one or more second inputs to receive a forward signal and a reverse signal. In some aspects, the DPD training trigger module may be configured to receive a forward signal that is associated with a MIMO communication and is an input signal to the antenna panel. Alternatively, or additionally, the DPD training trigger module may be configured to receive a reverse signal that is based at least in part on crosstalk that is associated with the antenna panel and/or a reflection that is based at least in part on the antenna panel and the forward signal. The DPD training trigger module may include a first output to communicate at least a DPD training trigger decision that is based at least in part on the reverse signal. In some aspects, the apparatus may include and/or be connected to a DPD training module, and the DPD training module may include one or more third inputs to receive at least the DPD training trigger decision, the forward signal, and/or the reverse signal. Alternatively, or additionally, the DPD training module may include a training system that generates, based at least in part on the DPD training trigger decision, one or more DPD coefficients using at least the forward signal and the reverse signal. In some aspects, the DPD training module may include a second output that is coupled to the first input of the DPD circuit. The second output may be configured to output the one or more DPD coefficients based at least in part on the DPD training trigger decision.

Particular aspects of the subject matter described in this disclosure can be implemented to realize one or more of the following potential advantages. In some examples, by capturing and analyzing a reverse signal, the described techniques can be used to enable an apparatus (e.g., a computing device, a transmitter, an integrated circuit (IC), a system-on-chip (SoC), a digital signal processor (DSP), a field programmable gate array (FPGA), an application-specific integrated circuit (ASIC), a programmable logic device (PLD), or other discrete gate or transistor logic or circuitry) to identify a mismatch between current DPD coefficients being used by a DPD component and a current operating environment, and the apparatus may compute and/or derive a system-level DPD training trigger decision on generating DPD coefficients. For example, the apparatus may include and/or be connected to a DPD training trigger module that receives at least the reverse signal as input and analyzes at least the reverse signal to make a determination on whether or not to trigger DPD training that generates DPD coefficients. In analyzing the reverse signal, the DPD training trigger module may identify that a current operating condition and/or a current signal characteristic (e.g., a reverse signal power level, a reverse signal frequency offset, and/or a reverse signal phase relationship) differs from a training operating condition and/or a training signal characteristic that was used to generate the current DPD coefficients being used by a DPD component. The apparatus may trigger, by way of the DPD training trigger module, a DPD training module to generate DPD coefficients that are based at least in part on the current operating environment and/or the current signal characteristic of the reverse signal (e.g., current interference level, current distortion level, and/or current crosstalk level). DPD coefficients that match a current operating environment (e.g., to within a threshold) may result in increased accuracy of the DPD applied by a DPD component, an increased signal quality (e.g., decreased phase distortion, decreased power distortion, no clipping, and/or increased modulation quality) at a transmitter, reduced recovery errors at a receiver, reduced data transfer latencies, and/or increased data throughput.

As indicated above, FIGS. 4A and 4B are provided as examples. Other examples may differ from what is described above.

FIG. 5 is a diagram illustrating an example 500 of MIMO DPD training that may be triggered based at least in part on a reverse signal, in accordance with the present disclosure.

A transmitter may include MIMO DPD capabilities in which the transmitter applies, to a signal, DPD that is configured to mitigate interference and/or distortion generated from a reverse signal. In some cases, the transmitter may include a DPD component that applies the DPD to an input signal using one or more DPD kernels that perform computations that are based at least in part on one or more DPD coefficients, as described above. To maintain synchronization between the DPD coefficients and a current operating environment, and to ensure that the applied DPD results in a signal quality that satisfies a quality threshold, the transmitter may include and/or be connected to a DPD training trigger module and/or a DPD training module. The DPD training trigger module and/or the DPD training module may be implemented using any combination of software, hardware, and/or firmware. A non-limiting example of software may include processor-executable instructions, and non-limiting examples of hardware and/or firmware may include any combination of an IC, an SoC, an FPGA, and/or an ASIC. In some aspects, the DPD training trigger module and the DPD training module may be co-resident on a same apparatus (e.g., a computing device, a transmitter, an IC, an SoC, an FPGA, and/or an ASIC).

The example 500 includes components and/or modules that may be included in and/or connected to a transmitter, such as the transmitter 405 described with regard to FIG. 4 and/or the transceiver 302 described with regard to FIG. 3. The components and/or modules included in example 500 are example components and modules, and a transmitter may include alternative or additional components and/or modules not shown by FIG. 5.

The example 500 illustrated by FIG. 5 includes N-transmission chains that may enable a transmitter to simultaneously transmit an N-layer MIMO transmission, N being an integer. To illustrate, the example 500 includes multiple DPD components 502 that are shown by FIG. 5 as DPD 502-1, DPD 502-2, up to DPD 502-N. Each DPD component of the multiple DPD components 502 may receive a respective input stream and/or respective input signal (shown by FIG. 5 as s1, s2, up to sN) and may apply respective DPD to the respective input signal. Accordingly, each DPD component may output a digital predistorted signal, shown by FIG. 5 as x1, x2, up to xN. Each digital predistorted signal may be fed into a respective digital-to-analog converter (DAC) that generates an analog output signal using the digital predistorted signal. For instance, x1 may be fed into a first DAC 504-1, x2 may be fed into a second DAC 504-2, and xN may be fed into an N-th DAC 504-N. The DACs may collectively be referred to as DACs 504. As shown by FIG. 5, each analog output signal may be fed into a respective PA of multiple PAs 506 (e.g., after further processing such as filtering, upconversion, and the like), shown by FIG. 5 as PA 506-1, PA 506-2, up to PA 506-N, and each PA may generate a respective forward signal (shown by FIG. 5 as z1, z2, up to zN) that is fed into an antenna panel. Collectively, each respective DPD component, respective DAC, and respective PA that are connected to one another may be referred to as a transmission chain. To illustrate, the DPD 502-1, the DAC 504-1, and the PA 506-1 may form a first transmission chain, and the DPD 502-N, the DAC 504-N, and the PA 506-N may form an N-th transmission chain. As shown by reference number 508, one or more of the transmission chains may observe a respective reverse signal. For instance, the N-th transmission chain may observe an N-th reverse signal (rN) as shown by FIG. 5, but any or all of the transmission chains may observe a respective reverse signal.

In some aspects, a transmitter may include a crosstalk matrix module 510. The crosstalk matrix module 510 may be implemented using any combination of software, hardware, and/or firmware. To illustrate, the crosstalk matrix module 510 may be implemented via an IC, an SoC, a DSP, an FPGA, an ASIC, a PLD, or other discrete gate or transistor logic or circuitry. As another example, the crosstalk matrix module 510 may be implemented as processor-executable instructions (e.g., software) that are executed by a processor of the transmitter. The crosstalk matrix module 510 may generate one or more crosstalk estimations based at least in part on multiple input streams and/or multiple input signals (e.g., s1, s2, up to sN). For instance, the crosstalk matrix module 510 may be based at least in part on a mathematical model of antenna coupling between antenna elements in an antenna panel (e.g., the antenna panel 464) and the signals being transmitted via the antenna elements. Accordingly, the crosstalk matrix module 510 may receive the input signals and generate one or more crosstalk estimations. For instance, as shown by FIG. 5, the crosstalk matrix module 510 may generate a crosstalk estimation for the transmission chain N (e.g., cN), and the crosstalk estimation may be used as an input to a respective DPD. To illustrate, the crosstalk estimation may be used by a DPD component (e.g., the DPD 502-1, the DPD 502-2, and/or the DPD 502-N) to pre-distort a forward signal such that actual crosstalk distortion is mitigated and/or canceled out after the signal passes through the PA.

Alternatively or additionally, the transmitter may include a feedback module 512 that is shown by FIG. 5 as including a coupler 514 and an analog-to-digital converter (ADC) 516, but may include alternative or additionally combinations of circuitry or signal conditioning techniques, such as a hardware filter, a digital filter, down-conversion hardware, a gain control circuit, a low noise amplifier, digital signal processing modules, or any combination thereof. In some aspects, the coupler 514 may be a multi-port coupler (e.g., a 2-sided coupler). However, the feedback module 512 may include alternative or additional circuitry to provide comparable functionality as the coupler 514 (e.g., electrical isolation), such as an isolator, an amplifier, an electromagnetically coupled inductor, or a transformer. Alternatively, the coupler 514 (or comparable circuitry or isolation layout techniques) may be separate from the feedback module 512. While FIG. 5 illustrates the feedback module 512 as being connected to the N-th transmission chain, other examples may include the feedback module 512 being connected to a different transmission chain and/or the transmitter including multiple feedback modules 512. For example, a transmitter may include a respective feedback module for each transmission chain and/or a switch mechanism to change which transmission chain is connected to the feedback module 512.

As shown by FIG. 5, the coupler 514 may be a post-PA coupler that connects to an output of a PA. In some aspects, the coupler 514 may receive a reverse signal (e.g., rN) in a manner that isolates the reverse signal from a forward signal (e.g. zN). For example, the coupler 514 may be a directional coupler that receives and/or isolates signals propagating in different directions. Accordingly, the coupler 514 may receive the forward signal in a manner that isolates the forward signal from the reverse signal and/or the coupler 514 may receive the reverse signal in a manner that isolates the reverse signal from the forward signal. The coupler 514 may input the reverse signal and/or the forward signal to the ADC 516, and the ADC 516 may generate a first set of digital samples for the reverse signal rN and/or a second set of digital samples for the forward signal zN. For clarity, FIG. 5 illustrates a direct connection between the coupler 514 and the ADC 516, but other examples may include additional circuitry (e.g., for signal conditioning), such as a hardware filter, down-conversion hardware, a gain control circuit, a low noise amplifier, or any combination thereof. Accordingly, the feedback module 512 may capture, by way of the coupler 514 and the ADC 516, a reverse signal from an antenna panel and/or a forward signal fed to the antenna panel. In such a way, at least a portion of reflected signals or signals passing in a direction from the antenna array and towards the PA are captured by the coupler 514 and processed and signals indicative of these signals are provided to the DPD circuitry to provide digital pre-distortion in a way that compensates for self-interference (e.g., as compared to many DPD systems that may just sample the PA output signal passing in a direction towards the antenna and without capturing or sampling a reverse signal).

As shown by FIG. 5, the transmitter may include and/or be connected to a DPD training trigger module 518. As one example, the DPD training trigger module 518 may be implemented as a software module that is executed by a processor of the transmitter and/or a computing device that is connected to the transmitter. As another example, the DPD training trigger module 518 may be implemented in the transmitter and/or the computing device that is connected to the transmitter via firmware and/or hardware, such as in an IC, an SoC, a DSP, an FPGA, an ASIC, a PLD, or other discrete gate or transistor logic or circuitry. The DPD training trigger module 518 may receive the first set of digital samples (e.g., the reverse signal rN) and/or the second set of digital samples (e.g., the forward signal zN) as input, and may analyze the first set of digital samples and/or the second set of digital samples to generate a feedback signal, shown by FIG. 5 as being a DPD training trigger decision 520. As shown by FIG. 5, the DPD training trigger decision 520 may be used as input to a DPD training module 522.

As one example, the DPD training trigger module 518 may analyze the first set of digital samples and/or the second set of digital samples to determine whether current DPD coefficients used by a DPD (e.g., the DPD 502-N) are valid or invalid. Valid DPD coefficients may be DPD coefficients that, when used to apply DPD to a signal, mitigate interference and/or distortion that is caused by the reverse signal in a manner that results in the forward signal (e.g., when combined with the reverse signal) having a signal quality that satisfies a quality threshold. Alternatively, or additionally, valid DPD coefficients may be DPD coefficients that are generated using a training environment that aligns with a current operating environment (e.g., to within an accuracy threshold and/or alignment threshold). Accordingly, the DPD training trigger decision 520 may indicate to not generate DPD coefficients based at least in part on the DPD training trigger module 518 determining that the current DPD coefficients are valid DPD coefficients. Invalid DPD coefficients may be DPD coefficients that, when used to apply DPD to a signal, fail to mitigate the interference and/or the distortion. That is, using the invalid DPD coefficients to apply DPD does not result in the forward signal (e.g., when combined with the reverse signal) having a signal quality that satisfies the quality threshold. Alternatively, or additionally, invalid DPD coefficients may be DPD coefficients that are generated using a training environment that does not align with a current operating environment (e.g., to within an accuracy threshold and/or alignment threshold). Accordingly, the DPD training trigger decision 520 may indicate to generate DPD coefficients based at least in part on the DPD training trigger module 518 determining that the current DPD coefficients are invalid DPD coefficients.

In some aspects, to analyze the first set of digital samples and/or the second set of digital samples, the DPD training trigger module 518 may compute a measurement metric and/or compare the measurement metric to a threshold. As a non-limiting example, the DPD training trigger module 518 may compute an ACLR metric and/or an EVM metric using at least the reverse signal (e.g., via the first set of samples), but other metrics and/or signal characteristic may be computed and/or used by the DPD training trigger module 518. Alternatively, or additionally, the DPD training trigger module 518 may compute the ACLR metric and/or the EVM metric using at least the forward signal (e.g., via the second set of samples). In some cases, the DPD training trigger module 518 may compute an ACLR difference between the ACLR metric and a training ACLR metric that is linked to the current DPD coefficients (e.g., an ACLR metric for a training operating environment used to generate the current DPD coefficients) and/or an EVM difference between the ACLR metric and a training EVM metric. The DPD training trigger module 518 may compare the measurement metric to a first threshold (e.g., an ACLR level threshold and/or an EVM level threshold) and/or the difference to a second threshold (e.g., an ACLR difference threshold and/or an EVM difference threshold). The DPD training trigger module 518 may base the DPD training trigger decision 520 at least in part on the comparison. For instance, the DPD training trigger module 518 may indicate, via the DPD training trigger decision 520, to trigger the generation of DPD coefficients based at least in part on the ACLR metric and/or the ACLR difference satisfying the respective threshold. That is, the DPD training trigger decision 520 may be set to a “trigger training” state and/or a value that indicates “trigger training”. Alternatively, the DPD training trigger module 518 may indicate to not trigger the generation of DPD coefficients based at least in part on the ACLR metric and/or the ACLR difference failing to satisfy the respective threshold. That is, the DPD training trigger decision 520 may be set to a “do not trigger training” state and/or a value that indicates “do not trigger training”. Accordingly, the DPD training trigger module 518 may invoke the generation of DPD coefficients (or may not invoke the generation of DPD coefficients) via DPD training performed by the DPD training module 522, based at least in part on the reverse signal. Other examples may include the DPD training trigger module 518 indicating not to trigger the generation of DPD coefficients based at least in part on the measurement metric and/or the difference satisfying the respective threshold and/or indicating to trigger the generation of DPD coefficients based at least in part on the measurement metric and/or the difference failing to satisfy the respective threshold. As indicated above, while the above examples describe the DPD training trigger module 518 using an ACLR metric and/or an EVM metric to compute the DPD training trigger decision 520, other signal characteristics of the reverse signal (e.g., characterized by a respective measurement metric) may be used by the DPD training trigger module 518 to compute the DPD training trigger decision 520.

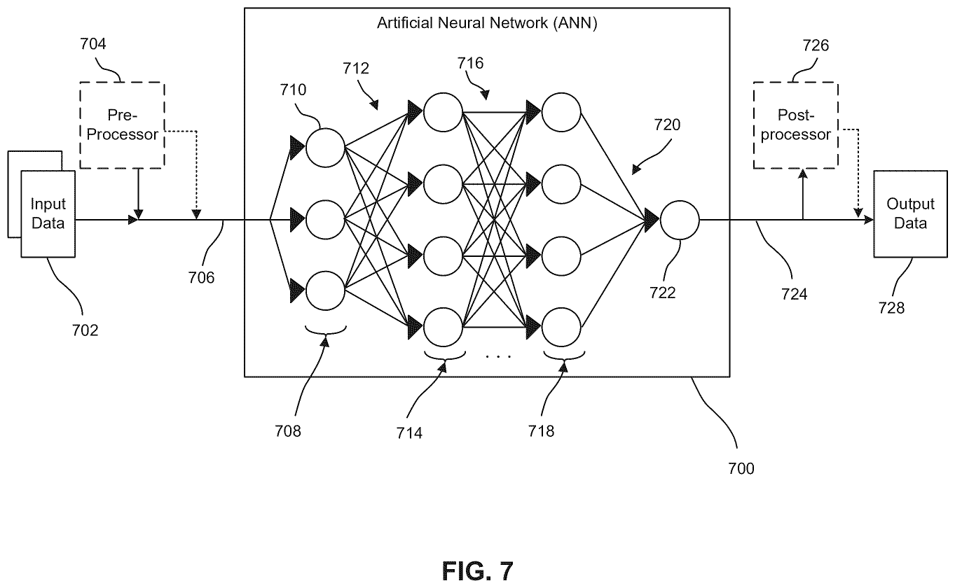

The DPD training module 522 may be implemented as a software module that is executed by a processor of the transmitter and/or a computing device that is connected to the transmitter in a similar manner as the DPD training trigger module 518. Alternatively, or additionally, the DPD training module 522 may be implemented in the transmitter, and/or the computing device that is connected to the transmitter, via firmware and/or hardware, such as an IC, an SoC, a DSP, an FPGA, an ASIC, a PLD, or other discrete gate or transistor logic or circuitry. In some aspects, the DPD training module 522 may implement and/or include AI and/or ML to generate DPD coefficients used by one or more DPD kernels of a DPD component. An example ML model that may be used to generate DPD coefficients is further described below with regard to FIG. 7.

The DPD training module 522 may receive and use one or more inputs to generate the DPD coefficients. In the example 500, the DPD training module 522 receives the DPD training trigger decision 520 and multiple inputs that are associated with various stages of a transmission chain N. FIG. 5 shows the multiple inputs as including a reverse signal (e.g., rN as the first set of digital samples), a forward signal (e.g., zN as the second set of digital samples), a digital predistorted signal (e.g., xN), an input signal (e.g., sN), and a crosstalk estimation (e.g., cN), but other examples may include alternative or additional combinations of inputs. Based at least in part on the DPD training trigger decision 520 indicating to trigger training, the DPD training module 522 may generate one or more DPD coefficients 524 as output, and the DPD coefficients 524 may be used as a configuration input to a DPD component, such as the DPD component 502-N, and the DPD component may update processing performed by one or more DPD kernels to use the DPD coefficients 524. That is, the DPD training module 522 may communicate the DPD coefficients 524 to a DPD component and instruct the DPD component to update one or more DPD kernels to use the DPD coefficients 524. Accordingly, the DPD training module 522 may selectively compute or generate the DPD coefficients 524, such as by computing the DPD coefficients 524 based at least in part on the DPD training trigger decision 520 indicating a “trigger training” state, and not computing the DPD coefficients 524 based at least in part on the DPD training trigger decision 520 indicating a “do not trigger training” state.

The inclusion of the feedback module 512, the coupler 514, and the ADC 516 enable a transmitter to capture and measure a reverse signal from an antenna panel and, consequently, trigger DPD training to generate DPD coefficients that mitigate a mismatch between the DPD coefficients used by a DPD component and a current operating environment. Using a reverse signal to invoke the generation of the DPD coefficients may also enable the transmitter to maintain a signal quality level (e.g., that satisfies a signal quality threshold) and reduce power consumption by the transmitter. For example, based at least in part on analyzing the reverse signal, a DPD training trigger module can reduce how often the transmitter performs DPD training and/or generates the DPD coefficients, and reduce power consumption by the transmitter. That is, the DPD training trigger module may trigger DPD training and/or the generation of DPD coefficients based on necessity, such as when an observed interference level satisfies a criterion and may mitigate mismatch between the DPD coefficients used by a DPD component as described above, increase an accuracy of DPD that is applied by a DPD component, increase a signal quality (e.g., decreased phase distortion, decreased power distortion, no clipping, and/or increased modulation quality) at a transmitter, reduce recovery errors at a receiver, reduce data transfer latencies, and/or increase data throughput.

As indicated above, FIG. 5 is provided as an example. Other examples may differ from what is described with regard to FIG. 5.

FIG. 6 is a diagram illustrating an example process 600 performed, for example, at a transmitter and/or transceiver apparatus or an apparatus of a transmitter and/or transceiver, in accordance with the present disclosure. Example process 600 is an example where the apparatus or the apparatus (e.g., a network node 110, a processing system 145, a UE 120, and/or a processing system 140) performs operations associated with triggering DPD training using a reverse signal.

As shown in FIG. 6, in some aspects, process 600 may include generating a set of digital samples using a reverse signal that is based at least in part on at least one of: crosstalk that is associated with an antenna panel, or a reflection that is based at least in part on the antenna panel and a forward signal that is associated with a MIMO communication via the antenna panel (block 610). For example, the apparatus (e.g., using processing system 145 or processing system 140, depicted in FIG. 1 and/or feedback module 512, depicted in FIG. 5) may generate a set of digital samples of a reverse signal that is based at least in part on at least one of: crosstalk that is associated with an antenna panel, or a reflection that is based at least in part on the antenna panel and a forward signal that is associated with a MIMO communication via the antenna panel, as described above.

As further shown in FIG. 6, in some aspects, process 600 may include computing, selectively, one or more DPD coefficients based at least in part on a DPD training trigger decision, the DPD training trigger decision being based at least in part on the set of digital samples of the reverse signal. (block 620). For example, the apparatus (e.g., using processing system 145 or processing system 140, depicted in FIG. 1, DPD training trigger module 518, depicted in FIG. 5, and/or DPD training module 522, depicted in FIG. 5) may compute, selectively one or more DPD coefficients based at least in part on a DPD training trigger decision, the DPD training trigger decision being based at least in part on the set of digital samples of the reverse signal.

Process 600 may include additional aspects, such as any single aspect or any combination of aspects described below and/or in connection with one or more other processes described elsewhere herein.

In a first aspect, process 600 includes computing the DPD training trigger decision based at least in part on the set of digital samples of the reverse signal; and triggering, selectively and based at least in part on the DPD training trigger decision, a DPD training module to generate the one or more DPD coefficients based at least in part on the DPD training trigger decision.

In a second aspect, process 600 includes setting the DPD training trigger decision to a “do not trigger training” state to refrain from triggering generation of the DPD coefficients, and selectively triggering the DPD training module to generate the DPD coefficients includes not triggering the DPD training module based at least in part on the “do not trigger training” state.

In a third aspect, generating the set of digital samples using the reverse signal includes isolating the reverse signal from the forward signal based at least in part on using a coupler that is connected to a transmission line configured to carry the forward signal and the reverse signal, and generating the set of digital samples based at least in part on an ADC that receives the reverse signal from the coupler.

In a fourth aspect, computing the DPD training trigger decision includes computing a measurement metric based at least in part on the set of digital samples of the reverse signal, and computing the DPD training trigger decision using the measurement metric.

In a fifth aspect, the measurement metric is at least one of an ACLR metric, or an EVM metric.

In a sixth aspect, computing the DPD training trigger decision using the measurement metric includes comparing the measurement metric to a threshold.

In a seventh aspect, process 600 includes computing the DPD training trigger decision as a “do not trigger training” state based at least in part on the measurement metric failing to satisfy the threshold.

In an eighth aspect, process 600 includes computing the DPD training trigger decision as a “trigger training” state based at least in part on the measurement metric satisfying the threshold.

In a ninth aspect, process 600 includes setting the DPD training trigger decision to a “trigger training” state to trigger generation of the one or more DPD coefficients, and selectively triggering the DPD training module to generate the one or more DPD coefficients includes triggering the DPD training module.

In a tenth aspect, selectively generating the one or more DPD coefficients includes generating the one or more DPD coefficients based at least in part on the DPD training trigger being set to the trigger training state, and process 600 includes updating one or more DPD kernels to use the one or more DPD coefficients as at least part of applying DPD to an input signal.

In an eleventh aspect, selectively generating the one or more DPD coefficients includes not generating the one or more DPD coefficients based at least in part on the DPD training trigger being set to a “do not trigger training” state.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example artificial intelligence and/or AI/ML model, represented in FIG. 7 as an artificial neural network (ANN) 700, in accordance with the present disclosure.

As described above, a DPD training module (e.g., a DPD training module 522) may compute one or more DPD coefficients based at least in part on minimizing a difference between one or more observed values (e.g., of a reverse signal) and a predicted value (e.g., based at least in part on a crosstalk matrix). Some non-limiting examples include the DPD training module performing computations that minimize the difference using a least-squares-based algorithm, an MAE-based algorithm, and/or an MLE-based algorithm. Alternatively, or additionally, the DPD training module may use an ML-based algorithm and/or an AI-based algorithm to compute the DPD coefficients.

FIG. 7 illustrates an example of an ANN 700 that may be used by a DPD training module to compute DPD coefficient(s). The ANN 700 may receive input data 706, which may include one or more bits of data 702, pre-processed data output from pre-processor 704 (optional), or some combination thereof. Here, the bits of data 702 may include training data, verification data, application-related data, or the like, based, for example, on the stage of deployment of ANN 700. In some examples, the pre-processor 704 may be included within the ANN 700. The pre-processor 704 may, for example, process all or a portion of data 702, which may result in some of data 702 being changed, replaced, and/or deleted, among other examples. In some aspects, the pre-processor 704 may add additional data to data 702. In some aspects, the pre-processor 704 may be an AI/ML model, such as an ANN.

As shown in FIG. 7, the ANN 700 includes at least one first layer 708 of artificial neurons 710 to process input data 706 and provide resulting first layer data via connections or “edges” such as edges 712 to at least a portion of at least one second layer 714. The second layer 714 processes data received via edges 712 and provides second layer output data via edges 716 to at least a portion of at least one third layer 718. The third layer 718 processes data received via edges 716 and provides third layer output data via edges 720 to at least a portion of a final layer 722 including one or more neurons to provide output data 724. All or part of output data 724 may be further processed in some manner by (optional) post-processor 726. Thus, in certain examples, the ANN 700 may provide output data 728 that is based on output data 724, post-processed data output from post-processor 726, or some combination thereof. In some examples, the input data 706 may be a reverse signal and the output data 728 may be one or more DPD coefficients. However, the input data 706 may include any combination of an input signal (e.g., sN described with regard to FIG. 5), a forward signal (e.g., zN described with regard to FIG. 5), a post-DPD signal (e.g., xN described with regard to FIG. 5), and/or a crosstalk estimation (e.g., cN described with regard to FIG. 5).

The post-processor 726 may be included within the ANN 700 in some examples. The post-processor 726 may, for example, process all or a portion of output data 724, which may result in output data 728 being different, at least in part, to output data 724, as result of data being changed, replaced, and/or deleted, among other examples. In some examples, post-processor 726 may be configured to add additional data to output data 724. In this example, the second layer 714 and the third layer 718 represent intermediate or hidden layers that may be arranged in a hierarchical or other like structure. Although not explicitly shown in FIG. 7, there may be one or more further intermediate layers between the second layer 714 and the third layer 718. In some examples, the post-processor 726 may be an AI/ML model, such as an ANN.

The structure and training of artificial neurons 710 in the various layers may be tailored to specific requirements of an application. Within a given layer such as first layer 708, second layer 714, or third layer 718 of the ANN 700, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of the ANN 700. The weights and biases of the ANN 700 may be adjusted during a training process or during operation of the ANN 700. The weights of the various artificial neurons may control a strength of connections between layers or artificial neurons, while the biases may control a direction of connections between the layers or artificial neurons. An activation function may select or determine whether an artificial neuron transmits an output to the next layer in response to received data.

Different activation functions may be used to model different types of non-linear relationships. By introducing non-linearity into an AI/ML model, an activation function allows the configuration for the AI/ML model to change in response to identifying or detecting complex patterns and relationships in the input data 706. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an AI/ML model, such as ANN 700, may be conducted using training data. Training data may include one or more datasets that the ANN 700 may use to identify patterns or relationships. Training data may represent various types of information, including written, visual, audio, environmental context, and/or operational properties, among other examples. During training, the parameters (such as the weights and biases) of artificial neurons 710 may be changed, such as to minimize or otherwise reduce a loss function or a cost function. A training process may be repeated multiple times to fine-tune the ANN 700 with each iteration.

Various ANN model structures are available for consideration. For example, the ANN 700 may implement or may be implemented in a feedforward ANN structure, a convolutional ANN structure, a recurrent ANN structure, an autoencoder ANN structure, a generative adversarial ANN structure, or a transformer ANN structure. Another example ANN structure is an AI/ML model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks, among others.

The ANN 700 or other AI/ML models may be implemented in various types of processing circuits along with memory and applicable instructions therein. For example, general-purpose hardware circuits, such as, such as one or more CPUs, one or more GPUs, or suitable combinations thereof, may be employed to implement a model. In some implementations, one or more tensor processing units (TPUs), NPUs, or other special-purpose processors, FPGAs, ASICs, or the like may also be employed. In some implementations, the AI/ML model may be implemented by a NPU or a TPU embedded in an SoC along with other components, such as one or more CPUs, GPUs, or the like. A SoC includes several components manufactured on a shared semiconductor substrate. The NPU or TPU may be controlled by the one or more CPUs by configuring the AI/ML model implemented by the NPU or TPU with weights and biases, providing certain training data to the AI/ML model to configure the AI/ML model, or providing input data to the AI/ML model to obtain related inferences. The one or more CPUs may also receive the inferences and be configured to perform certain actions based on the inferences produced by the AI/ML model. The actions performed by the one or more CPUs may include sending commands to other components of the SoC or components external to the SoC to perform certain actions. For example, the CPU may send commands to an RF transceiver based on the outputs or inferences obtained from an AI/ML model to cause the RF transceiver to operate on a wireless network in accordance with the AI/ML model.

As indicated above, FIG. 7 is provided as an example. Other examples may differ from what is described with regard to FIG. 7.

The following provides an overview of some Aspects of the present disclosure:
Aspect 1: A method performed by an apparatus, the method comprising: generating a set of digital samples of a reverse signal that is based at least in part on at least one of: crosstalk that is associated with an antenna panel, or a reflection that is based at least in part on the antenna panel and a forward signal that is associated with a multiple-input-multiple-output (MIMO) communication via the antenna panel; and computing, selectively, one or more digital predistortion (DPD) coefficients based at least in part on a DPD training trigger decision, the DPD training trigger decision being based at least in part on the set of digital samples of the reverse signal.
Aspect 2: The method of Aspect 1, further comprising: computing the DPD training trigger decision based at least in part on the set of digital samples of the reverse signal; and triggering, selectively and based at least in part on the DPD training trigger decision, a DPD training module to generate the one or more DPD coefficients based at least in part on the DPD training trigger decision.
Aspect 3: The method of Aspects 2, wherein computing the DPD training trigger decision comprises: computing a measurement metric based at least in part on the set of digital samples of the reverse signal; and computing the DPD training trigger decision using the measurement metric.
Aspect 4: The method of Aspect 3, wherein the measurement metric is at least one of: an adjacent channel leakage ratio (ACLR) metric, or an error vector magnitude (EVM) metric.
Aspect 5: The method of Aspect 3 or Aspect 4, wherein computing the DPD training trigger decision using the measurement metric comprises: comparing the measurement metric to a threshold.
Aspect 6: The method of any one of Aspects 2-5, computing the DPD training trigger decision using the measurement metric further comprises: computing the DPD training trigger decision as a “do not trigger training” state based at least in part on the measurement metric failing to satisfy the threshold.
Aspect 7: The method of any one of Aspects 2-5, computing the DPD training trigger decision using the measurement metric further comprises: computing the DPD training trigger decision as a “trigger training” state based at least in part on the measurement metric satisfying the threshold.
Aspect 8: The method of any one of Aspects 1-7, wherein generating the set of digital samples using the reverse signal comprises: isolating the reverse signal from the forward signal based at least in part on using a coupler that is connected to a transmission line configured to carry the forward signal and the reverse signal; and generating the set of digital samples based at least in part on an analog-to-digital converter (ADC) that receives the reverse signal from the coupler.
Aspect 9: The method of any of Aspects 1-6, further comprising: setting the DPD training trigger decision to a “trigger training” state to trigger generation of the one or more DPD coefficients, and selectively triggering the DPD training module to generate the one or more DPD coefficients, the selectively triggering including triggering the DPD training module based at least in part on the “trigger training” state.
Aspect 10: The method of Aspect 9, wherein selectively generating the one or more DPD coefficients comprises generating the one or more DPD coefficients based at least in part on the “trigger training” state, and wherein the method further comprises updating one or more DPD kernels to use the one or more DPD coefficients as at least part of applying DPD to an input signal.
Aspect 11: The method of any of Aspects 1-8, further comprising: setting the DPD training trigger decision to a “do not trigger training” state to refrain from triggering generation of the DPD coefficients; and selectively triggering the DPD training module to generate the DPD coefficients, the selectively triggering comprising not triggering the DPD training module based at least in part on the “do not trigger training” state.
Aspect 12: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-11.
Aspect 13: An apparatus for wireless communication at a device, the apparatus comprising one or more memories and one or more processors coupled to the one or more memories, the one or more processors configured to cause the device to perform the method of one or more of Aspects 1-11.
Aspect 14: An apparatus for wireless communication, the apparatus comprising at least one means for performing the method of one or more of Aspects 1-11.
Aspect 15: A non-transitory computer-readable medium storing code for wireless communication, the code comprising instructions executable by one or more processors to perform the method of one or more of Aspects 1-11.
Aspect 16: A non-transitory computer-readable medium storing a set of instructions for wireless communication, the set of instructions comprising one or more instructions that, when executed by one or more processors of a device, cause the device to perform the method of one or more of Aspects 1-11.
Aspect 17: A device for wireless communication, the device comprising a processing system that includes one or more processors and one or more memories coupled with the one or more processors, the processing system configured to cause the device to perform the method of one or more of Aspects 1-11.
Aspect 18: An apparatus for wireless communication at a device, the apparatus comprising one or more memories and one or more processors coupled to the one or more memories, the one or more processors individually or collectively configured to cause the device to perform the method of one or more of Aspects 1-11.
Aspect 19: An apparatus comprising: a digital predistortion (DPD) training trigger module that comprises: a first input to receive at least: a reverse signal that is based at least in part on at least one of: crosstalk that is associated with an antenna panel, or a reflection that is based at least in part on the antenna panel and a forward signal that is associated with a multiple-input-multiple-output (MIMO) communication via the antenna panel; and a first output to communicate at least: a DPD training trigger decision that is based at least in part on the reverse signal; and a DPD training module that comprises: one or more second inputs to receive at least: the DPD training trigger decision, the forward signal, and the reverse signal; a training system that generates, based at least in part on the DPD training trigger decision, one or more DPD coefficients using at least the forward signal and the reverse signal; and a second output to output the one or more DPD coefficients based at least in part on the DPD training trigger decision.
Aspect 20: The apparatus of Aspect 19, wherein the DPD training trigger module is configured to: compute a measurement metric based at least in part on the reverse signal; and compute the DPD training trigger decision using the measurement metric.
Aspect 21: The apparatus of Aspect 20, wherein the measurement metric is at least one of: an adjacent channel leakage ratio (ACLR) metric, or an error vector magnitude (EVM) metric.
Aspect 22: The apparatus of any one of Aspects 19-21, wherein the DPD training trigger module, to compute the DPD training trigger decision, is further configured to: compare the measurement metric to a threshold.
Aspect 23: The apparatus of Aspect 22, wherein the DPD training trigger module, to compute the DPD training trigger decision, is further configured to: compute the DPD training trigger decision as a “do not trigger training” state based at least in part on the measurement metric failing to satisfy the threshold.
Aspect 24: The apparatus of Aspect 23, wherein the DPD training trigger module, to compute the DPD training trigger decision, is further configured to: compute the DPD training trigger decision as a “trigger training” state based at least in part on the measurement metric satisfying the threshold.
Aspect 25: The apparatus of any one of Aspects 19-24, wherein the training system is configured to selectively generate the one or more DPD coefficients based at least in part on the DPD training trigger decision.
Aspect 26: The apparatus of Aspect 25, wherein the DPD training trigger decision indicates a “trigger training” state, and wherein the training system is further configured to generate the one or more DPD coefficients using at least the forward signal and the reverse signal based at least in part on the DPD training trigger decision indicated the “trigger training” state.
Aspect 27: The apparatus of Aspect 25, wherein the DPD training trigger decision indicates a “do not trigger training” state, and wherein the training system is further configured to refrain from generating the one or more DPD coefficients based at least in part on the DPD training trigger decision indicated the “do not trigger training” state.
Aspect 28: The apparatus of any one of Aspects 19-27, further comprising: a DPD component that is coupled to the DPD training module and configured to: receive the one or more DPD coefficients as input; and use the one or more DPD coefficients as at least part of one or more DPD kernels that apply DPD to an input signal.
Aspect 29: The apparatus of any one of Aspects 19-28, further comprising: a feedback module that is configured to: isolate the reverse signal from the forward signal; and generate a set of digital samples of the reverse signal.
Aspect 30: The apparatus of Aspect 29, wherein the feedback module is configured to isolate the reverse signal from the forward signal based at least in part on using a coupler that is connected to a transmission line configured to carry the forward signal and the reverse signal.
Aspect 31: The apparatus of Aspects 19, further comprising: the antenna panel; one or more transmit chains, each transmit chain of the one or more transmit chains being coupled to the antenna panel; one or more power amplifiers, each power amplifier of the one or more power amplifiers being coupled to the antenna panel and included in a respective transmit chain of the one or more transmit chains; and one or more feedback modules, each feedback module of the one or more feedback modules being coupled to a respective power amplifier of the one or more power amplifiers.
Aspect 32: An apparatus comprising: an antenna panel; a digital predistortion (DPD) circuit that includes a first input; a power amplifier (PA) that is coupled to the antenna panel and the DPD circuit; a DPD training trigger module that comprises: one or more second inputs to receive at least: a forward signal that is associated with a multiple-input-multiple-output (MIMO) communication and is an input to the antenna panel; and a reverse signal that is based at least in part on at least one of: crosstalk that is associated with the antenna panel, or a reflection that is based at least in part on the antenna panel and the forward signal, a first output to communicate at least: a DPD training trigger decision that is based at least in part on the reverse signal; and a DPD training module that comprises: one or more third inputs to receive at least: the DPD training trigger decision, the forward signal, and the reverse signal, a training system that generates, based at least in part on the DPD training trigger decision, one or more DPD coefficients using at least the forward signal and the reverse signal; and a second output that is coupled to the first input of the DPD circuit, the second output configured to output the one or more DPD coefficients based at least in part on the DPD training trigger decision.
Aspect 33: The apparatus of Aspect 32, wherein the DPD training trigger module is configured to: compute a measurement metric based at least in part on the reverse signal; and compute the DPD training trigger decision using the measurement metric.
Aspect 34: The apparatus of Aspect 33, wherein the measurement metric is at least one of: an adjacent channel leakage ratio (ACLR) metric, or an error vector magnitude (EVM) metric.
Aspect 35: The apparatus of any one of Aspects 33-34, wherein the DPD training trigger module, to compute the DPD training trigger decision, is further configured to: compare the measurement metric to a threshold.
Aspect 36: The apparatus of Aspect 35, wherein the DPD training trigger module, to compute the DPD training trigger decision, is further configured to: compute the DPD training trigger decision as a “do not trigger training” state based at least in part on the measurement metric failing to satisfy the threshold.
Aspect 37: The apparatus of Aspect 35, wherein the DPD training trigger module, to compute the DPD training trigger decision, is further configured to: compute the DPD training trigger decision as a “trigger training” state based at least in part on the measurement metric satisfying the threshold.
Aspect 38: The apparatus of any one of Aspects 32-37, wherein the training system is configured to selectively generate the one or more DPD coefficients based at least in part on the DPD training trigger decision.
Aspect 39: The apparatus of Aspect 38, wherein the DPD training trigger decision indicates a “trigger training” state, and wherein the training system is further configured to generate the one or more DPD coefficients using at least the forward signal and the reverse signal based at least in part on the DPD training trigger decision indicated the “trigger training” state.
Aspect 40: The apparatus of Aspect 38, wherein the DPD training trigger decision indicates a “do not trigger training” state, and wherein the training system is further configured to refrain from generating the one or more DPD coefficients based at least in part on the DPD training trigger decision indicated the “do not trigger training” state.
Aspect 41: The apparatus of any one of Aspects 32-40, further comprising: a DPD component that is coupled to the DPD training module and configured to: receive the one or more DPD coefficients as input; and use the one or more DPD coefficients as at least part of one or more DPD kernels that apply DPD to an input signal.
Aspect 42: The apparatus of any one of Aspects 32-41, further comprising: a feedback module that is configured to: isolate the reverse signal from the forward signal; and generate a set of digital samples of the reverse signal.
Aspect 43: The apparatus of Aspect 42 wherein the feedback module is configured to isolate the reverse signal from the forward signal based at least in part on using a coupler that is connected to a transmission line configured to carry the forward signal and the reverse signal.
Aspect 44: An apparatus comprising: a plurality of transmit chains each comprising a power amplifier, the plurality of transmit chains coupled to an antenna array comprising a plurality of antennas; one or more feedback circuits, each of the one or more feedback circuits comprising an electrical isolation circuit that is configured to capture at least a portion of a signal between the power amplifier of at least one of the plurality of transmit chains and the antenna array and output a reverse signal corresponding to a signal passing in a direction from the antenna array towards the power amplifier, each of the one or more feedback circuits configured to output a feedback signal based on the reverse signal; and a digital predistortion circuit included as a part of one or more of the plurality of transmit chains or coupled to the one or more of the plurality of transmit chains, the digital predistortion circuit configured to receive the feedback signal that is based on the reverse signal from the one or more feedback circuits.
Aspect 45: The apparatus of Aspect 44, wherein the electrical isolation circuit is a directional coupler comprising an inductor electromagnetically coupled to an output path of the power amplifier.
Aspect 46: The apparatus of Aspect 44 or Aspect 43, wherein the digital predistortion circuit is configured to generate DPD coefficients based at least in part on the feedback signal.
Aspect 47: The apparatus of any one of Aspects 44-46, wherein the electrical isolation circuit is configured to isolate the reverse signal from a forward signal passing in a direction from the power amplifier to the antenna array.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b++c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus comprising:
a digital predistortion (DPD) training trigger module that comprises:
a first input to receive at least:
a reverse signal that is based at least in part on at least one of:
crosstalk that is associated with an antenna panel, or
a reflection that is based at least in part on the antenna panel and a forward signal that is associated with a multiple-input-multiple-output (MIMO) communication via the antenna panel; and
a first output to communicate at least:
a DPD training trigger decision that is based at least in part on the reverse signal; and
a DPD training module that comprises:
one or more second inputs to receive at least:
the DPD training trigger decision,
the forward signal, and
the reverse signal;
a training system that generates, based at least in part on the DPD training trigger decision, one or more DPD coefficients using at least the forward signal and the reverse signal; and
a second output to output the one or more DPD coefficients based at least in part on the DPD training trigger decision.

2. The apparatus of claim 1, wherein the DPD training trigger module is configured to:
compute a measurement metric based at least in part on the reverse signal; and
compute the DPD training trigger decision using the measurement metric.

3. The apparatus of claim 2, wherein the DPD training trigger module, to compute the DPD training trigger decision, is further configured to:
compare the measurement metric to a threshold.

4. The apparatus of claim 1, wherein the training system is configured to selectively generate the one or more DPD coefficients based at least in part on the DPD training trigger decision.

5. The apparatus of claim 4, wherein the DPD training trigger decision indicates a trigger training state, and
wherein the training system is further configured to generate the one or more DPD coefficients using at least the forward signal and the reverse signal based at least in part on the DPD training trigger decision indicating the trigger training state.

6. The apparatus of claim 4, wherein the DPD training trigger decision indicates a do not trigger training state, and
wherein the training system is further configured to refrain from generating the one or more DPD coefficients based at least in part on the DPD training trigger decision indicating the do not trigger training state.

7. The apparatus of claim 1, further comprising:
a DPD component that is coupled to the DPD training module and configured to:
receive the one or more DPD coefficients as input; and
use the one or more DPD coefficients as at least part of one or more DPD kernels that apply DPD to an input signal.

8. The apparatus of claim 1, further comprising:
a feedback module that is configured to:
isolate the reverse signal from the forward signal; and
generate a set of digital samples of the reverse signal.

9. The apparatus of claim 8, wherein the feedback module is configured to isolate the reverse signal from the forward signal based at least in part on using a coupler that is connected to a transmission line configured to carry the forward signal and the reverse signal.

10. The apparatus of claim 1, further comprising:
the antenna panel;
one or more transmit chains, each transmit chain of the one or more transmit chains being coupled to the antenna panel;
one or more power amplifiers, each power amplifier of the one or more power amplifiers being coupled to the antenna panel and included in a respective transmit chain of the one or more transmit chains; and
one or more feedback modules, each feedback module of the one or more feedback modules being coupled to a respective power amplifier of the one or more power amplifiers.

11. A method performed by an apparatus, the method comprising:
generating a set of digital samples of a reverse signal that is based at least in part on at least one of:
crosstalk that is associated with an antenna panel, or
a reflection that is based at least in part on the antenna panel and a forward signal that is associated with a multiple-input-multiple-output (MIMO) communication via the antenna panel; and
computing, selectively, one or more digital predistortion (DPD) coefficients based at least in part on a DPD training trigger decision, the DPD training trigger decision being based at least in part on the set of digital samples of the reverse signal.

12. The method of claim 11, further comprising:
computing the DPD training trigger decision based at least in part on the set of digital samples of the reverse signal; and
triggering, selectively and based at least in part on the DPD training trigger decision, a DPD training module to generate the one or more DPD coefficients based at least in part on the DPD training trigger decision.

13. The method of claim 12, wherein computing the DPD training trigger decision comprises:
computing a measurement metric based at least in part on the set of digital samples of the reverse signal; and
computing the DPD training trigger decision using the measurement metric.

14. The method of claim 12, wherein selectively triggering the DPD training module to generate the one or more DPD coefficients comprises:
setting the DPD training trigger decision to a “trigger training” state to trigger generation of the one or more DPD coefficients.

15. The method of claim 12, wherein selectively triggering the DPD training module to generate the DPD coefficients comprises:
setting the DPD training trigger decision to a do not trigger training state to refrain from triggering generation of the DPD coefficients.

16. The method of claim 11, wherein generating the set of digital samples using the reverse signal comprises:
isolating the reverse signal from the forward signal based at least in part on using a coupler that is connected to a transmission line configured to carry the forward signal and the reverse signal; and
generating the set of digital samples based at least in part on an analog-to-digital converter (ADC) that receives the reverse signal from the coupler.

17. An apparatus comprising:
a plurality of transmit chains each comprising a power amplifier, the plurality of transmit chains coupled to an antenna array comprising a plurality of antennas;
one or more feedback circuits, each of the one or more feedback circuits comprising an electrical isolation circuit that is configured to capture at least a portion of a signal between the power amplifier of at least one of the plurality of transmit chains and the antenna array and output a reverse signal corresponding to a signal passing in a direction from the antenna array towards the power amplifier, each of the one or more feedback circuits configured to output a feedback signal based on the reverse signal; and
a digital predistortion circuit included as a part of one or more of the plurality of transmit chains or coupled to the one or more of the plurality of transmit chains, the digital predistortion circuit configured to receive the feedback signal that is based on the reverse signal from the one or more feedback circuits.

18. The apparatus of claim 17, wherein the electrical isolation circuit is a directional coupler comprising an inductor electromagnetically coupled to an output path of the power amplifier.

19. The apparatus of claim 17, wherein the digital predistortion circuit is configured to generate DPD coefficients based at least in part on the feedback signal.

20. The apparatus of claim 17, wherein the electrical isolation circuit is configured to isolate the reverse signal from a forward signal passing in a direction from the power amplifier to the antenna array.
